(19) United States
(12) Patent Application Publication
(10) Pub. No.: US 2025/0342468 A1
(43) Pub. Date: Nov. 6, 2025

(54) SYSTEMS AND METHODS FOR USE IN USER VERIFICATION

(71) Applicant: MASTERCARD INTERNATIONAL INCORPORATED, PURCHASE, NY (US)

(72) Inventors: Maurice David Liscia, Long Island City, NY (US); Abdel Rahman El Kharboutly, Wake Forest, NC (US); Mohamed Abouelenin, San Carlos, CA (US)

(21) Appl. No.: 19/199,136

(22) Filed: May 5, 2025

Related U.S. Application Data
(60) Provisional application No. 63/643,273, filed on May 6, 2024.

(51) Int. Cl. G06Q 20/40; G06Q 20/32

(52) U.S. Cl. CPC G06Q 20/40; G06Q 20/3278

(57) ABSTRACT

Systems and methods are provided for facilitating enhanced verification of a physical card of a user, at a mobile device of the user. One example computer-implemented method includes, for a transaction between a first party and a user, receiving, from the mobile device specific to the user, encrypted card data for the transaction, the encrypted card data including a cryptogram specific to the transaction and validating the encrypted card data. The method also includes, in response to the encrypted data being validated, generating a network token for the transaction and responding to the encrypted data, to the mobile device specific to the user, with a complete status. The method then includes, in response to a checkout request for the transaction, returning the token to the mobile device, whereby the mobile device submits the token to the first party for authorization of the transaction.

### CROSS-REFERENCE TO RELATED APPLICATION

This application claims the benefit of, and priority to, U.S. Provisional Patent Application No. 63/643,273, filed on May 6, 2024. The entire disclosure of the above application is incorporated herein by reference.

### FIELD

The present disclosure generally relates to systems and methods for use in verifying users, and in particular, to systems and methods for use in enhanced verification of physical cards at mobile devices.

### BACKGROUND

This section provides background information related to the present disclosure which is not necessarily prior art.

Users are known to initiate interactions with parties (e.g., merchants) in various manners. For example, a user (e.g., a consumer, etc.) may present a physical card, or other device, to a merchant, whereupon the merchant scans or otherwise reads the device to initiate payment from an account associated therewith to purchase a product (e.g., a good or service) from the merchant.

As part of the interactions, the merchants may rely on static point of sale (POS) terminals, which are fixed in locations at the merchants, or may rely on mobile POS (or mPOS) terminals, which are carried with employees, for example, at the physical locations of the merchants. The mPOS terminals may be smartphones, which include mPOS software that configures the smartphones to permit users to tap physical credit cards, or other forms of payment devices, at the smartphones to provide enhanced authentication (e.g., Online PIN, etc.) in connection with the interactions (e.g., tap to pay, etc.). The mPOS terminals are limited to the ownership of the merchants (or presence at the merchant), therefore permitting card present (or CP) transactions physically at the merchants.

### BRIEF DESCRIPTION OF DRAWINGS

The drawings described herein are for illustrative purposes only of selected embodiments and not all possible implementations, and are not intended to limit the scope of the present disclosure.

FIG. 1 illustrates an example system of the present disclosure suitable for use in facilitating enhanced verification of physical cards of users, at mobile devices of the users, in connection with network transactions;

FIG. 2 is a block diagram of an example computing device that may be used in the system of FIG. 1; and

FIG. 3 (represented as a grid including FIGS. 3-1 to 3-28) is a flow diagram of an example method (arranged as illustrated in the grid of FIG. 3 and spanning FIGS. 3-1 to 3-28), which may be implemented in connection with the system of FIG. 1, for facilitating enhanced verification of a physical card of a user, at a mobile device of the user, in connection with a transaction, such as, for example, an e-commerce transaction.

Corresponding reference numerals indicate corresponding parts throughout the several views of the drawings.

### DETAILED DESCRIPTION

Example embodiments will now be described more fully with reference to the accompanying drawings. The description and specific examples included herein are intended for purposes of illustration only and are not intended to limit the scope of the present disclosure.

When users interact with merchants at merchant locations, or more generally, in the presence of a merchant (e.g., physically at a merchant physical location, or at a mobile merchant, etc.), and present physical cards for purchase of products, the ensuing transactions are designated as “card present” and “cardholder present” transactions. That is, the cards/cardholders are present at the merchants, for the transactions. In certain instances, the physical cards interact with terminals of the merchants, whereby cryptograms are generated (based on the interactions therebetween) and associated with the transactions as evidence of the physical cards being physically present at the transactions. The cryptograms may be generated consistent with an EMV chip (of a physical card), for example, which is in line with the EMVCo protocol (as described below), as one example of enhanced authentication for the transactions. The card-present designation is associated with a level of assurance, and potentially, may further be used to define terms of the transactions (e.g., interchange rates, etc.). In e-commerce transactions, the physical cards being present at the merchant locations is not possible, but there is a need to gain the assurances associated with enhanced authentication where the physical card is used to initiate the transaction.

Uniquely, the systems and methods herein provide for enhanced authentication of users, at mobile devices of the users, in connection with transactions, such as, for example, e-commerce transactions with merchants, by the users.

In connection with a transaction, in embodiments herein, a user uniquely taps or otherwise presents a physical card on or to a mobile device of the user (e.g., belonging to or owned by the user, not belonging to, or owned by a merchant, etc.). A cryptogram specific to the transaction is generated by the physical card and then validated through a service platform. The service platform also facilitates a further authentication of the user (e.g., via Online PIN, passkey authentication, 3DS challenge, 3DS data scoring, etc.). In this way, the physical card is leveraged to provide assurance, which is made available for the card-not-present (CNP) transaction where a physical card (and user) was (were) present at the initiation of the transaction (e.g., e-commerce transaction, etc.). As such, the technical data flow defined by the service platform and software included in the user's mobile device, simulate assurance which is similar to the user being physically present at the merchant for the transaction and presenting the physical card to a merchant device. Thus, by way of the technical advancement described in the present disclosure, transactions initiated at the mobile device of the user, with a physical card, are more secure.

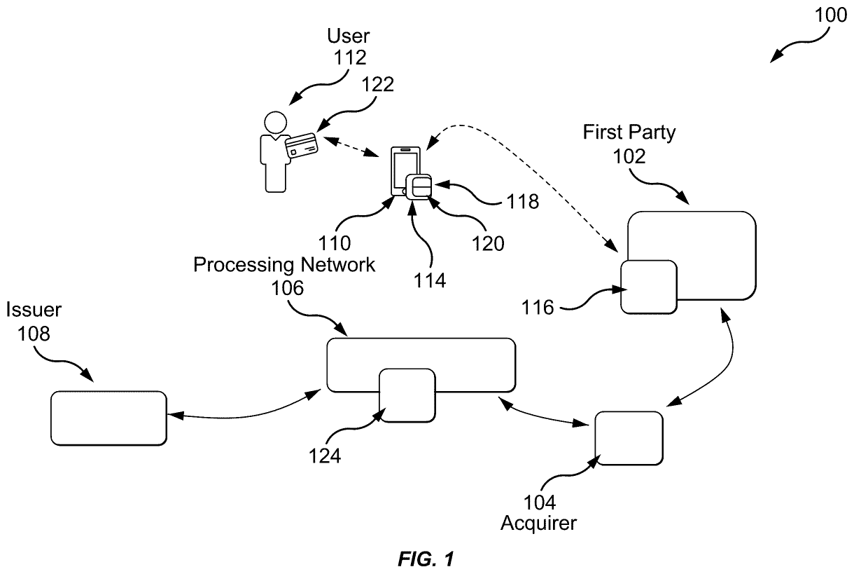

FIG. 1 illustrates an example system 100 in which one or more aspects of the present disclosure may be implemented. Although the system 100 is presented in one arrangement, other embodiments may include the parts of the system 100 (or other parts) arranged otherwise depending on, for example, types of merchants, types/manners of interactions between merchants and users, privacy rules and regulations, etc.

In the illustrated embodiment, the system 100 generally includes a first party 102, an acquirer 104, a processing network 106, and an issuer (or participant) 108, each coupled to (and in communication with) one or more networks (as generally indicated by arrowed lines in FIG. 1). The network(s) may include, without limitation, a local area network (LAN), a wide area network (WAN) (e.g., the Internet, etc.), a mobile network, a virtual network, and/or another suitable public and/or private network capable of supporting communication among two or more of the parts illustrated in FIG. 1, or any combination thereof. For example, the network may include multiple different networks, such as a private payment transaction network made accessible by the processing network 106 to the acquirer 104 and the issuer 108 and, separately, the public Internet, which is accessible as desired to the first party 102, the processing network 106, the issuer 108, and a mobile device 110 associated with a user 112, etc.

The first party 102 is generally a merchant associated with offering products for purchase to one or more users, including, for example, the user 112, etc. The first party 102 may include a physical location (e.g., a brick-and-mortar location, etc.), or virtual locations (e.g., accessible via a web application, etc.). In particular, in this example embodiment, the first party 102 is associated with a merchant application 114, which is installed and active in the user's mobile device 110, in this embodiment. The merchant application 114 configures the mobile device 110 to communicate with the first party 102, and in particular, an application backend 116 included in the first party 102. The merchant application 114, when executed by the mobile device 110, configures the mobile device 110 to communicate with the backend 116 to permit the user 112 to browse products offered for sale by the first party 102, to select one(s) of the products, to purchase one or more of the products from the first party 102, and to facilitate further operations, as described in more detail below.

In this example embodiment, the merchant application 114 further configures the mobile device 110 (e.g., and hardware included therein, etc.) to communicate with a tap physical card (e.g., an EMV credit card, etc.), whereby the mobile device 110 is enabled, more specifically, for nearfield communication (NFC). That is, the merchant application 114 may include a software development kit (SDK) specific to NFC, i.e., an NFC SDK 118. In this example embodiment, the NFC SDK 118 cooperates with the processing network 106, whereby the NFC SDK 118 includes a public key (e.g., of a public-private key pair, etc.) from the processing network 106 for use as described below In addition, the merchant application 114 may include another SDK, which configures the mobile device 110 to communicate with a service platform 124 described herein, i.e., a service SDK 120, in order to enable one or more services for the mobile device 110.

The NFC SDK 118 and the service SDK 120 are separate in the merchant application 114 in the embodiment shown in FIG. 1, but may be integrated with one another, or the application 114, in one or more other embodiments, depending, for example, on publisher(s) of the SDKs 118, 120, or the merchant application 114; interactions therebetween; or communication standards, protocols, regulations, thereof, etc.

In the example embodiment illustrated in FIG. 1, the acquirer 104 is a financial institution, such as, for example, a bank, a credit union, etc. The acquirer 104 is configured to issue an account to the first party 102. The account may be a payment account, or checking account, or other type of bank account, which is designated as the account into which the first party 102 is to receive funds from purchase transactions. Similarly, in this example embodiment, the issuer 108 is a financial institution, such as, for example, a bank, a credit union, etc. The issuer 108 is configured to issue accounts to users, including, for example, the user 112. The account(s) may be a payment account or other type of bank account, from which the user 112 is permitted to pay funds to another party (e.g., fund transactions, etc.).

In this example embodiment, the account of the user 112 is associated with a physical card 122 (e.g., a credit card, debit card, or other payment type card, etc.), which is configured consistent with one or more enhanced authentication schemes, such as, for example, the EMV 3DS protocol (see, e.g., www.emvco.com/emv-technologies/3d-secure/, which is incorporated herein by reference, etc.). In this way, the physical card 122 includes an EMV chip, which is disposed on the card body and configured for NFC (e.g., includes a suitable antenna, etc.). That is, the EMV chip configures the physical card 122 to be tapped, waved, etc., to communicate (e.g., transmit/receive NFC messages, etc.) with a POS terminal, as describe in more detail below.

In addition, the payment card 122, in general, complies with, in this embodiment, the ISO/IEC 7810 ID-1 standard, which generally indicates the particular physical dimensions and/or dimensional proportions of a payment card device (i.e., which is the payment card 122 in this instance) (e.g., a first dimension (either length or width) of about 85.60 mm (about 3.37 inches) and a second dimension (the other of length or width) of about 53.98 mm (about 2.13 inches), and a thickness dimension of about 0.76 mm (about 0.03 inches); etc.). Of course, however, other payment card device embodiments may be constructed according to one or more different standards (e.g., ISO/IEC 7810 ID-2, ISO/IEC 7810 ID-3, ISO/IEC 7810 ID-000, etc.). That said, in one or more embodiments, payment cards herein may have (without limitation) dimensions (lengths and/or widths) ranging between about 15 mm (about 0.59 inches) and about 150 mm (about 5.9 inches).

With continued reference to FIG. 1, each of the acquirer 104 and the issuer 108 are associated with the processing network 106. The processing network 106 may include, for example, the MASTERCARD, VISA, or DISCOVER processing network, etc. The processing network 106 is configured to facilitate messaging between the acquirer 104 and the issuer 108, generally, in connection with transactions between users and the first party 102 (and other first parties). The messaging may include, for example, authorization messages, clearing messages, settlement messages, etc., which may be consistent with the international standard for financial transaction card originated interchange messaging, for example, the ISO 8583 standard, the ISO 20022 standard, etc. as provided by the International Organization for Standards, or other suitable standards, etc. In this example embodiment, the service platform 124 is included in, or integrated with, the processing network 106. That said, it should be understood that the service platform 124 may be separate from the processing network 106 in other embodiments, and either integrated or included with the issuer 108, or other party in FIG. 1, or as a standalone party in still other embodiments.

Additionally, the processing network 106 is configured to perform one or more identity check operations, including, for example, to assess 3DS data associated with a given transaction (e.g., IP address, ESN, merchant location, user location, etc.) and to generate a score indicative of the confidence in the propriety of the transaction (e.g., a digital transaction insight (DTI) score, etc.). For example, the processing network 106 may include, or integrate with, the MASTERCARD ID Check service, or other suitable service, etc. Further still, the processing network 106 includes a tokenization service, which is configured to perform various operations related to tokenization (e.g., tokenization generation for specific primary account numbers (PANs), etc.). The tokenization service may include, for example, the MASTERCARD Digital Enablement Service (MDES), or other similar service depending on the particular processing network 106, etc. The processing network 106 may further include a passkey service, whereby passkey authentication is permitted. In connection therewith, a mobile device (e.g., the mobile device 110, etc.) is registered to the passkey service, whereby an identity of a user (e.g., user 112, etc.) is verified and then a public-private key pair is generated. The public key is shared by the mobile device with the passkey service, while the private key is maintained secure in the mobile device (e.g., secured by a biometric of the user 112, etc.).

It should be appreciated that while the tokenization service and the passkey service are described as part of the processing network 106, each may be separate therefrom. In at least one example, the passkey service is included in the service platform 124.

The user 112 is also associated with the mobile device 110, which includes, in this embodiment, ownership of the mobile device 110 by the user 112. That is, the mobile device 110 belongs to the user 112, or is under exclusive control of the user 112, whereby the mobile device 110 is not accessible by numerous users or the public (or owned by, or belonging to, the first party 102, etc.), etc. The mobile device 110 may include a smartphone, a tablet, a laptop, a desktop, a PDA, etc., which, in turn, includes the merchant application 114 (and SDKs 118, 120 therein).

In this example embodiment, the service platform 124 is configured to facilitate enhanced authentication in connection with a transaction, between the user 112 and the first party 102, via the merchant application 114 and the mobile device 110 (e.g., in connection with an e-commerce transaction, etc.), where the user 112 and physical card 122 are physically present at the mobile device 110 (but the user 112 is not physically present at a physical location of the first party 102) (where the first party 102 does not own or control the mobile device 110).

In particular, in connection with a transaction, via the merchant application 114, the user 112 selects to check out for the purchase of a product, from the first party 102, with a tap payment option. In response, the mobile device 110, as configured by the merchant application 114, initiates the NFC SDK 118, which configures the mobile device 110 to solicit a tap from the user 112. In response, the user 112 taps the physical card 122 on, or otherwise brings the physical card 122 in close proximity of (e.g., within about 1.6 inches or less (e.g., between one and two inches, etc.) (i.e., within the NFC range of the mobile device 110), etc.) of the mobile device 110 (so that the physical card 122 is within the NFC range of the mobile device 110 and activated thereby). The mobile device 110 is configured, by the NFC SDK 118, to cooperate with the physical card 122 to cooperate with the physical card 122 to generate the cryptogram and/or to read the chip data from the physical card 122, which includes, among other things, DE 55 data and/or cryptogram generated for the transaction, etc. The mobile device 110 is configured, by the NFC SDK 118, to determine, in this example, optionally, whether online PIN (broadly, enhanced authentication) is supported for the physical card 122.

When online PIN is supported, the mobile device 110 is configured, by the NFC SDK 118, to solicit a PIN from the user 112 at the mobile device 110, and to receive the PIN entry from the user 112, before generating a PIN block. More specifically, in this example, the user 112 enters the PIN code associated with the physical card 122 to the mobile device 110 (e.g., via a keypad, touchscreen, etc.), and the mobile device 110, as configured by the NFC SDK 118, encrypts the PIN code entered by the user 112 and generates a PIN Block, which is a PIN code in an encrypted format using a network public key(s) (which is (are) associated with a network private key(s) of the processing network 106), as per EMVCo protocol. The mobile device 110 is configured, by the NFC SDK 118, to share the PIN block, and also chip data for the transaction, with the merchant application 114. Conversely, when the Online PIN is not supported, the mobile device 110 is configured, by the NFC SDK 118, to share the chip data (e.g., DE 55 data, etc.) with the merchant application 114. And, the mobile device 110 is configured by the merchant application 114, in cooperation with the first party 102, to generate the 3DS data. The DE 55 data (broadly, chip data) may include data from the EMV chip of the physical card 122, transaction details (e.g., an amount, time, date, transaction ID, nonce, etc.), and/or data generated, for the specific transaction, by the physical card 122 (e.g., by the EMV chip, etc.), such as, for example, an authorization request cryptogram (ARQC) or other cryptogram, etc. The 3DS data may further include IP address of the mobile device 110, location data, etc.

In response, the mobile device 110 is configured, by the merchant application 114, to initiate the service SDK 120, and when the online PIN is supported, to pass the DE 55 data and the PIN block, to the service SDK 120. Then, the mobile device 110 is configured, by the service SDK 120, to encrypt the card data from the physical card 122 and to pass the encrypted card data back to the merchant application 114. The mobile device 110 is configured, by the merchant application 114, to initiate a checkout with the encrypted data with the service SDK 120. In turn, then, the mobile device 110 is configured, by the service SDK 120, to submit the checkout request to the service platform 124. The checkout request includes the encrypted card data.

The service platform 124 is configured to check to determine if a token exists for the account. When the token does not exist for the account, the service platform 124 is configured to validate DE 55 data and the PIN block, if applicable, with the processing network 106.

When on-behalf of PIN validation is supported, by the processing network 106, the tokenization service of the processing network 106 is configured to decrypt the card data, to validate the DE 55 data, to decrypt (e.g., based on a private key (associated with the public key used to create the PIN block), etc.) and validate the PIN block (e.g., based on a PIN verification value, etc.). The DE 55 data is validated by calling a DSA API of the processing network 106, with the encrypted data. In this exemplary embodiment, the DAS API is associated with direct service access (DSA), which is the API layer for Mastercard Value Added Services (VAS). The tokenization service is further configured to submit a token authorization request (TAR) to the issuer 108. The issuer 108, in this example embodiment, is configured to permit or authorize the token for the account. The tokenization service of the processing network 106, in turn, is configured to generate a token for the account.

Conversely, when on-behalf of PIN validation is not supported, the processing network 106 is configured to decrypt the card data, to validate the DE 55 data and to translate the PIN block for access by the issuer 108. The tokenization service of the processing network 106 is configured to decrypt the PIN block with the private key of the processing network 106, and encrypt the PIN block with an issuer specific public key, and then to submit an Account Status Inquiry (ASI) with the PIN block to the processing network 106, which is configured to forward the ASI to the issuer 108 (of the account involved in the transaction).

The issuer 108 is configured, when the ASI is proper, to decrypt the PIN block with an issuer associated private key, and validate the PIN code, and to approve the transaction, based on validation of the PIN block, which is provided to the processing network 106. And, the processing network 106 is configured, in turn, to provide the approval to the tokenization service of the processing network 106. In response, the tokenization service is configured to submit a TAR to the issuer 108. The issuer 108, in this example embodiment, is configured to permit or authorize the token for the account. The tokenization service of the processing network 106, in turn, is configured to generate a token for the account.

Apart from the above, the tokenization service of the processing network 106 may be configured to submit a TAR to the issuer 108, which includes the ARQC and the PIN (translated/encrypted) (without validation of the DE 55 data or the PIN OBS). The issuer 108, in this example embodiment, is configured to validate the ARQC and/or the PIN and to approve the tokenization based thereon. The issuer 108 is configured to confirm the approval to the tokenization service. The tokenization service of the processing network 106, in turn, is configured to generate a token for the account.

When the token already exists, the service platform 124 is configured to retrieve the token from the tokenization service of the processing network 106, whereby the service platform 124 is configured to submit an Account Status Inquiry (ASI) with the PIN block and the ARQC to the processing network 106. The processing network 106 is configured to forward the ASI to the issuer 108 (of the account involved in the transaction). The issuer 108 is configured, when the ASI is proper, to decrypt the PIN block with an issuer associated private key, to validate the PIN code, to validate the ARQC, and to approve the transaction, based on validation of the PIN block and/or ARQC, which is provided to the processing network 106.

Regardless of the option above, the processing network 106 is configured to then provide the approval (from the issuer 108) back to the service platform 124, along with the received token for the account.

In response, the service platform 124 is configured to generate an authenticated Digital Secure Remote Payment (DSRP) cryptogram. In particular, the service platform 124 is configured to solicit the DSRP cryptogram from the tokenization service of the processing network 106, which is configured to generate the DSRP cryptogram and to return the DSRP cryptogram to the service platform 124. The DSRP cryptogram includes appropriate flags set to indicate the specific card verification and token authentication (e.g., a secure token authentication method, etc.), etc. The service platform 124 is configured to further provide a checkout response to the service SDK 120, at the mobile device 110, with a “complete” status indicating the network token and associate cryptogram are available for use.

Conversely, when online PIN is not supported, the mobile device 110 is configured, by the merchant application 114, to initiate a checkout call with the encrypted card data and the generated 3DS data to the service SDK 120. Then, the mobile device 110 is configured, by the service SDK 120, to submit the checkout call to the service platform 124.

The service platform 124 is configured to determine if a token already exist for the account. Regardless, the service platform 124 is configured to optionally validate DE 55 data with the processing network 106. The processing network 106, in turn, is configured to provide an indication of DE 55 data being validated back to the service platform 124. Next, the service platform 124 is configured to call the processing network 106 with a request for identity check validation (e.g., via a Mastercard ID Check service or other suitable service, etc.), via an API, where the request includes the 3DS data (or data only). The processing network 106 is configured to validate the 3DS data and then return a DTI score, to the service platform 124. It should be understood that the DTI score is generated from an artificial intelligence assessment model and/or real-time assessment insights derived by the processing network 106 (or other suitable party), through use of EMV 3DS, for example, cardholder and network data, where, in this example, zero is a low potential issue and 10 is a non-low potential issue. The service platform 124 is configured to validate the DTI score, relative to one or more defined thresholds.

When the score is validated and the token does not exist for the account, the service platform 124 is configured to submit the ARQC for the transaction and other card data to the tokenization service of the processing network 106 for tokenization. In response, the tokenization service of the processing network 106 is configured to decrypt the card data, to validate the DE 55 data (e.g., via the DSA API call, etc.) with the processing network 106 and to submit a token authorization request (TAR) to the issuer 108. The issuer 108, in this example embodiment, is configured to permit or authorize the token for the account. The tokenization service of the processing network 106, in turn, is configured, to generate a token for the account. The tokenization service of the processing network 106 is further configured to return the approval and the token to the service platform 124.

When the score is validated and the token does exist, the service platform 124 is configured to retrieve the token from the tokenization service of the processing network 106, whereby the service platform 124 is configured to submit the ARQC data for validation with the tokenization service of the processing network 106. The tokenization service of the processing network 106 is configured to decrypt the card data associated with the ARQC, in order to validate the DE 55 data (e.g., via the DSA API call, etc.) with the processing network 106. When the DE 55 data is validated, the tokenization service of the processing network 106 is configured to return the approval along with the retrieved token for the account to the service platform 124.

The service platform 124 is configured to then generate the DSRP cryptogram, with the appropriate flags set therein. Again, the service platform 124 is configured to store the network token and DSRP cryptogram until requested (either through the service SDK 120 or through a direct API call, as preferred by the first party 102). The service platform 124 is configured to further provide a checkout response to the service SDK 120 in the mobile device 110 with a “complete” status indicating the network token and associate cryptogram are available for use.

Conversely, when the score is not validated, the service platform 124 is configured to provide a checkout response to the service SDK 120 in the mobile device 110 with a “pending authentication” status. This indicates that authentication is required to proceed.

In connection therewith, in this example embodiment, the mobile device 110, as configured by the merchant application 114 and/or the SDK 120, initiates the authentication of the cardholder/user 112. In response, the issuer 108 is configured, through a 3DS service provider, for example, to present an issuer challenge to the user 112, at the mobile device 110. The challenge may include a phone call, text message, or interaction with the mobile device 110 based on an issuer application in the mobile device 110, etc. Consistent therewith, the challenge may include a one-time-passcode (OTP), or link, etc. The user 112 provides the appropriate input to the mobile device 110, whereupon the mobile device 110, as configured by the merchant application 114 and/or the SDK 120, authenticates the user 112 (e.g., through one or more processes (e.g., identification and verification (ID &V) process(es), etc.), etc.) and provides a proof of authentication to the service platform 124.

Then, the service platform 124 is configured to share the proof of authentication (e.g., at least a portion of the ID&V result, etc.) and assurance data to the mobile device 110, and specifically, the merchant application 114.

Alternatively, in one or more embodiments, the mobile device 110 may be configured for passkey authentication of the user 112. As such, the mobile device 110, as configured by the merchant application 114 and/or the SDK 120, initiates passkey verification with the user 112, by soliciting a challenge from a passkey service of the processing network 106 and soliciting a biometric from the user 112. The passkey service is configured to generate a challenge and to provide the challenge to the mobile device 110. The mobile device 110, as configured by the merchant application 114 and/or the SDK 120, captures the biometric and verifies the biometric to access a private key in the mobile device. The mobile device 110, as configured by the merchant application 114 and/or the SDK 120, then signs the challenge with the private key and returns the signed challenge to the passkey service of the processing network 106. The passkey service is configured to verify the signature and to return a proof of authentication and assurance data to the mobile device 110, and specifically, the merchant application 114.

The mobile device 110, as configured by the merchant application 114, then calls the checkout API from the service platform 124 with the assurance data from the authentication of the user 112 (e.g., 3DS challenge, passkey, etc.). The service platform 124, in turn, is configured to submit a request to generate an authenticated DSRP cryptogram, to the tokenization service of the processing network 106. In response, the tokenization service of the processing network 106 is configured to generate and return the DSRP cryptogram (and potentially the token for the account). Subsequently, the service platform 124 is configured to provide the same to the mobile device 110.

The mobile device 110 is configured, by the merchant application 114, to initiate authentication of the DSRP cryptogram and the token for the account, with the acquirer 104. The acquirer 104, in turn, is configured to submit the authentication data to the processing network 106, which is configured to submit the authentication data to the issuer 108. The issuer 108 is configured to verify the authentication data and to return, as appropriate, an approval (indicating the authentication data is verified). The processing network 106 is configured to pass the approval back to the acquirer 104. And the acquirer 104 is configured to pass the approval to the mobile device 110. The mobile device 110 may be configured, by the mobile application 114 and the service SDK 120, to display the approved status for the tokenization/transaction to the user 112.

Next, the mobile device 110 is configured, by the merchant application 114, to initiate checkout with the service platform 124, which is configured to reply with the network token and the DSRP cryptogram. The DSRP cryptogram again includes flags indicative of the cardholder authentication performed (using DE 55 data, PIN or 3DS data), which are indicators in line with EMVCo protocol.

Next, the mobile device 110 is configured, by the merchant application 114, to provide the same to the first party 102, and in particular, the application backend 116. The application backend 116, in turn, is configured to initiate authorization of the transaction with the token and the DSRP cryptogram, with the acquirer 104. The acquirer 104 is configured to submit the authorization request for the transaction to the issuer 108, via the processing network 106. The issuer 108 is configured to approve (or decline) authorization based on the token and DSRP cryptogram (e.g., based on validation thereof, etc.), among other things. When approved, the issuer 108 is configured to compile and submit an authorization response back to the acquirer 104, via the processing network 106. The acquirer 104, in turn, is configured to provide the approval to the application backend 116, which is configured to indicate the same to the mobile device 110, and specially, the merchant application 114. The mobile device 110 is configured, by the merchant application 114 to display an approval to the user 112.

Finally, the mobile device 110 is configured, by the merchant application 114, to confirm the approved transaction with the service platform 124 to end the transaction.

Consistent with the above, the user 112 is permitted to engage with the first party 102, through the merchant application 114 in the mobile device 110, which is owned by the user 112, to complete a purchase, while still providing assurances that the physical card 122 is physically present at the transaction initiation, i.e., at the mobile device 110 (e.g., through the associated cryptogram, etc.), despite the physical card 122 and the user 112 being not physically present at a physical location of the first party 102.

While only one first party 102, one acquirer 104, one processing network 106, and one issuer 108 are illustrated in FIG. 1, it should be appreciated that any number of these parts and/or entities (and their associated components) may be included in the system 100, or may be included as a part of systems in other embodiments, consistent with the present disclosure. Likewise, it should be appreciated that the system 100 and/or other system embodiments will generally include multiple users, each associated with a mobile device that includes a merchant application (and SDKs) associated with the first parties, etc.

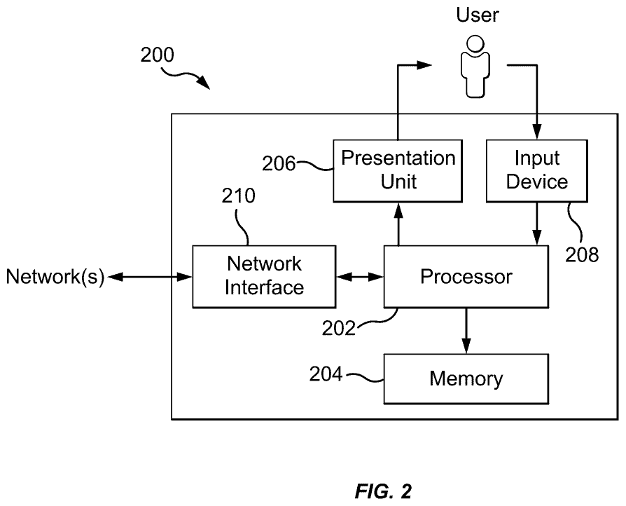

FIG. 2 illustrates an example computing device 200 that may be used in the system 100. The computing device 200 may include, for example, one or more servers, workstations, personal computers, laptops, tablets, smartphones, etc. In addition, the computing device 200 may include a single computing device, or it may include multiple computing devices located in close proximity or distributed over a geographic region, so long as the computing devices are specifically configured to operate as described herein. In the example embodiment of FIG. 1, each of the first party 102, the acquirer 104, the processing network 106 (and the tokenization service, the passkey service, etc. thereof), the issuer 108, the backend 116, and the service platform 124 are understood to be included in, or as being generally implemented in, at least one computing device generally consistent with computing device 200, coupled to (and in communication with) the one or more networks. In addition, the mobile device 110 may be considered a computing device consistent with the computing device 200. However, with that said, the system 100 should not be considered to be limited to the computing device 200, as described below, as different computing devices and/or arrangements of computing devices may be used.

Referring to FIG. 2, the example computing device 200 includes a processor 202 and a memory 204 coupled to (and in communication with) the processor 202. The processor 202 may include one or more processing units (e.g., in a multi-core configuration, etc.). For example, the processor 202 may include, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the functions described herein.

The memory 204, as described herein, is one or more devices that permit data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices (e.g., EMV chips, etc.), flash drives, CD-ROMs, thumb drives, floppy disks, tapes, hard disks, and/or any other type of volatile or nonvolatile physical or tangible computer-readable media. The memory 204 may be configured to store, without limitation, biometric templates, biometrics IDs, account details, tokens, and/or other types of data (and/or data structures) suitable for use as described herein. Furthermore, in various embodiments, computer-executable instructions may be stored in the memory 204 for execution by the processor 202 to cause the processor 202 to perform one or more of the operations described herein, such that the memory 204 is a physical, tangible, and non-transitory computer readable storage media. Such instructions often improve the efficiencies and/or performance of the processor 202 and/or other computer system components configured to perform one or more of the various operations herein, whereby such performance improves operation of the computing device (as described herein) and transforms the computing device 200 into a special-purpose computing device. It should be appreciated that the memory 204 may include a variety of different memories, each implemented in one or more of the functions or processes described herein.

In the example embodiment, the computing device 200 also includes a presentation unit 206 that is coupled to (and is in communication with) the processor 202 (however, it should be appreciated that the computing device 200 could include output devices other than the presentation unit 206, etc.). The presentation unit 206 outputs information, such as indicators of successful authentications, audibly or visually, for example, to a user of the computing device 200, such as the user 112 in the system 100, etc. The presentation unit 206 may include, without limitation a liquid crystal display (LCD), a light-emitting diode (LED) or LED display, an organic LED (OLED) display, an “electronic ink” display, speakers, etc. In some embodiments, presentation unit 206 may include multiple devices.

In addition, the computing device 200 includes an input device 208 that receives inputs from the user of the computing device 200 (i.e., user inputs) such as, for example, product selection inputs, card tap inputs, etc., as further described herein. The input device 208 may include a single input device or multiple input devices. The input device 208 is coupled to (and is in communication with) the processor 202 and may include, for example, a keyboard, a pointing device, a mouse, position sensors, biometric capturing device (e.g., fingerprint sensors, camera, palm reader, etc.) or any other type of sensor, a touch sensitive panel (e.g., a touch pad or a touch screen, etc.), another computing device, and/or an audio input device, etc. Further, in various example embodiments, a touch screen, such as that included in a tablet, a smartphone, or similar device, may behave as both the presentation unit 206 and the input device 208.

Further, the illustrated computing device 200 also includes a network interface 210 coupled to (and in communication with) the processor 202 and the memory 204. The network interface 210 may include, without limitation, a wired network adapter, a wireless network adapter (e.g., Wi-Fi adapter, a near field communication (NFC) adapter, a Bluetooth adapter, etc.), a mobile network adapter, or other device capable of communicating to one or more different networks, including the one or more networks described above. Further, in some example embodiments, the computing device 200 may include the processor 202 and one or more network interfaces incorporated into or with the processor 202.

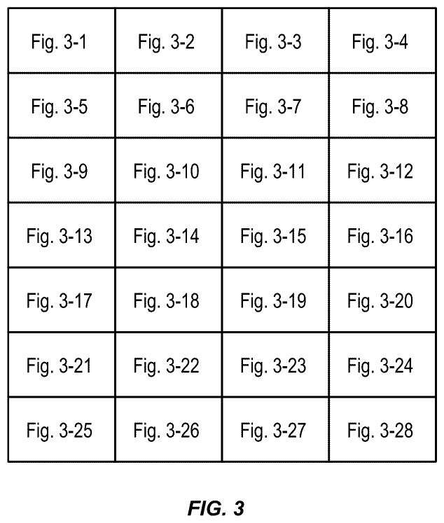

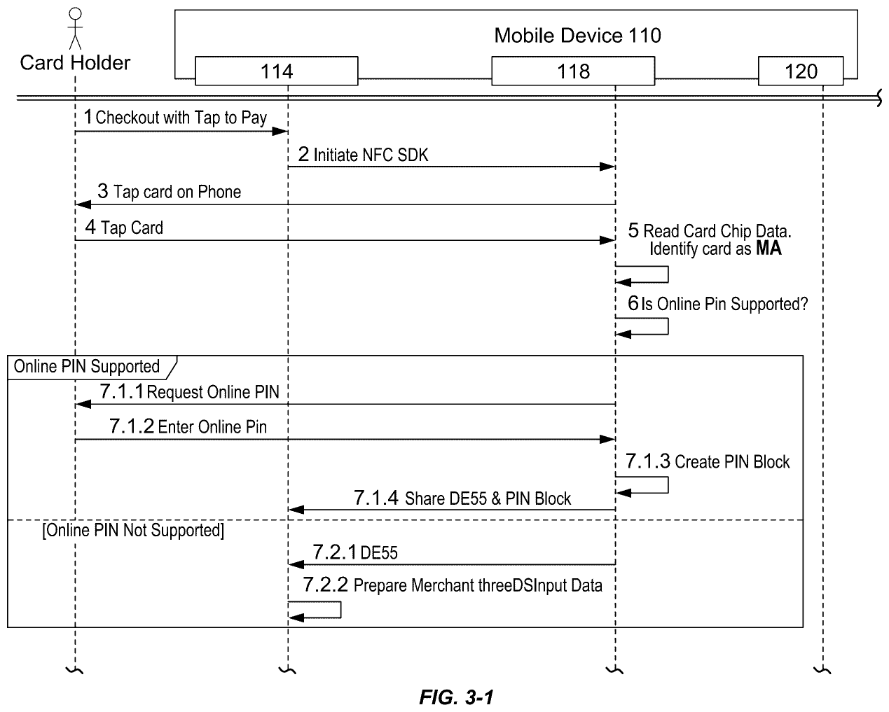

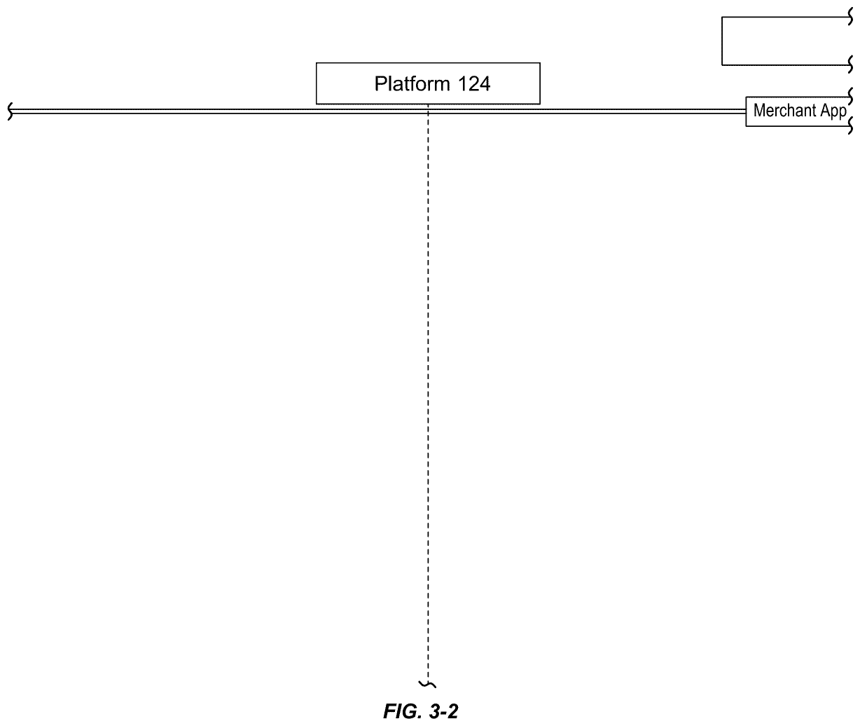

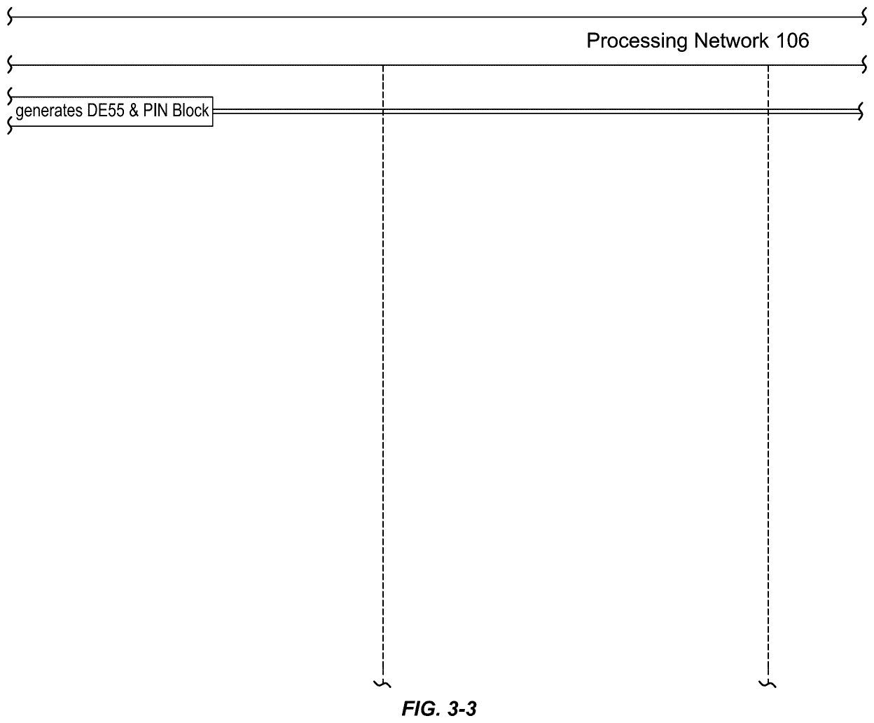

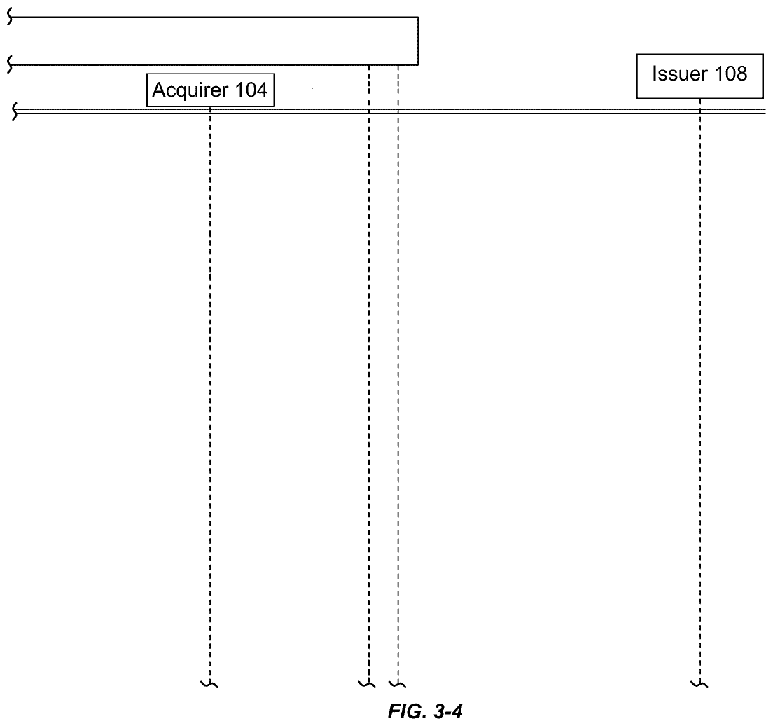

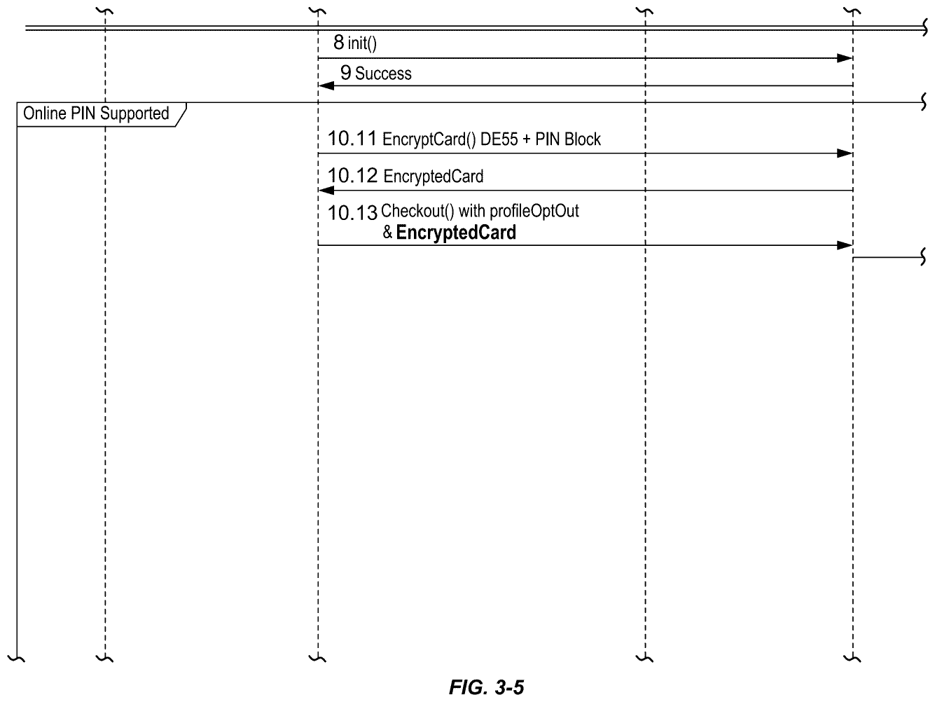

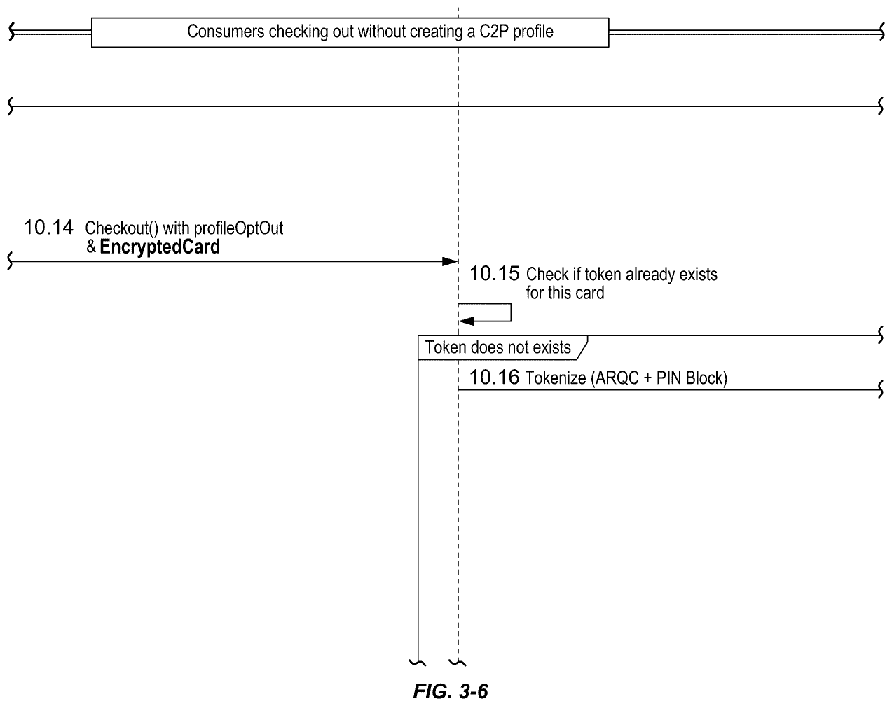

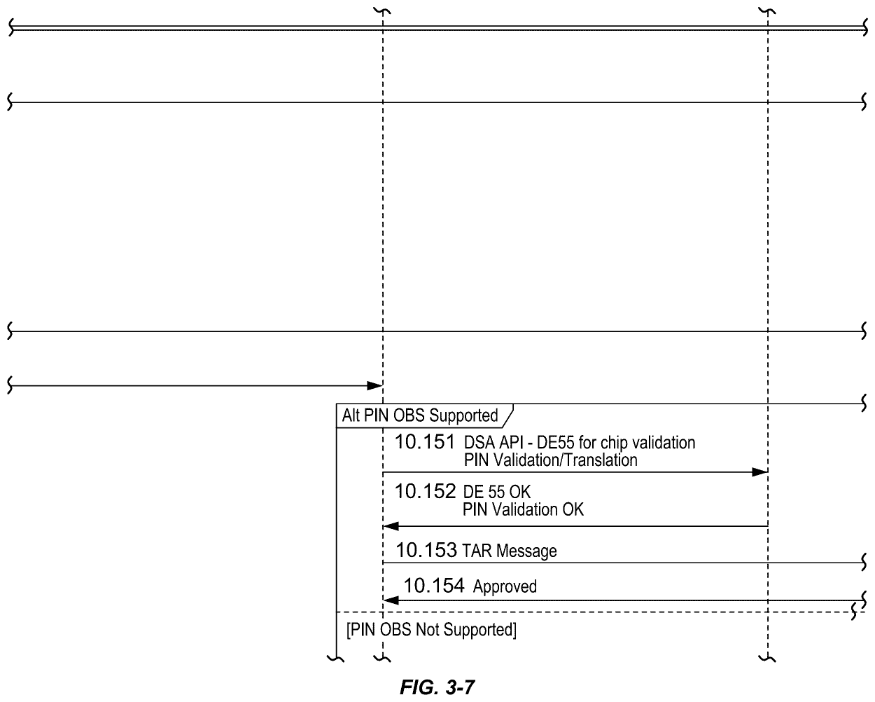

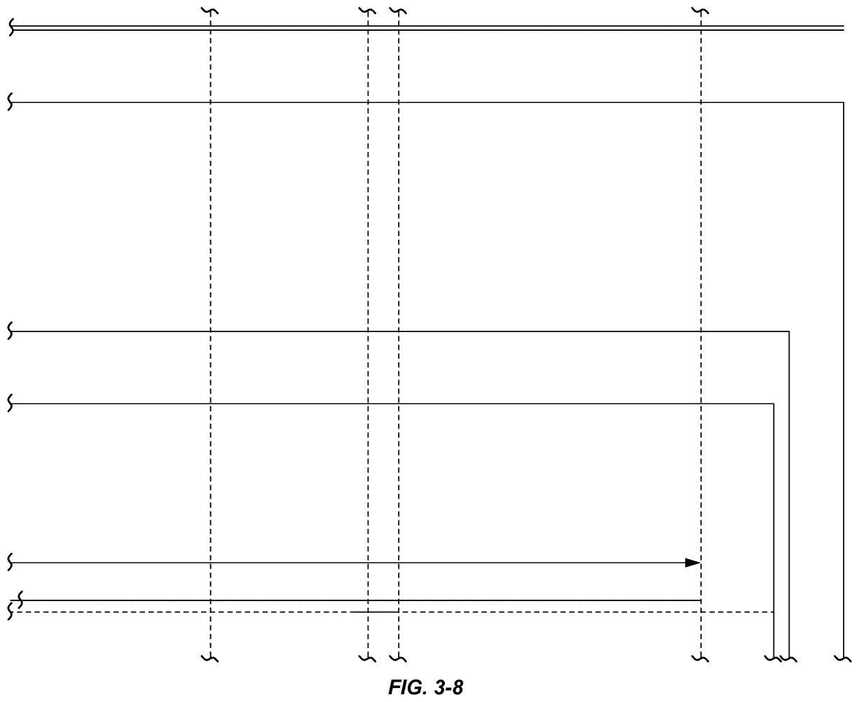

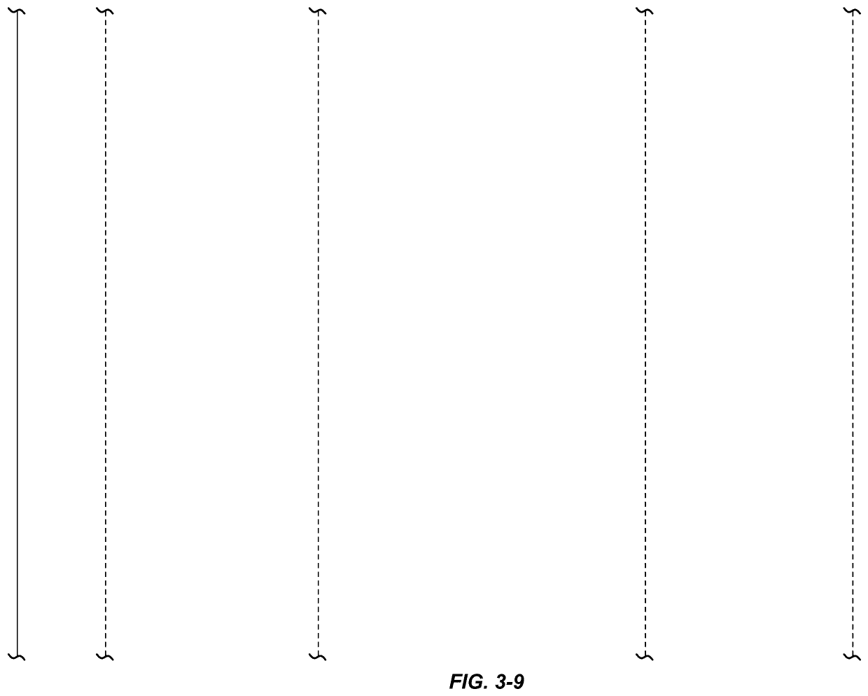

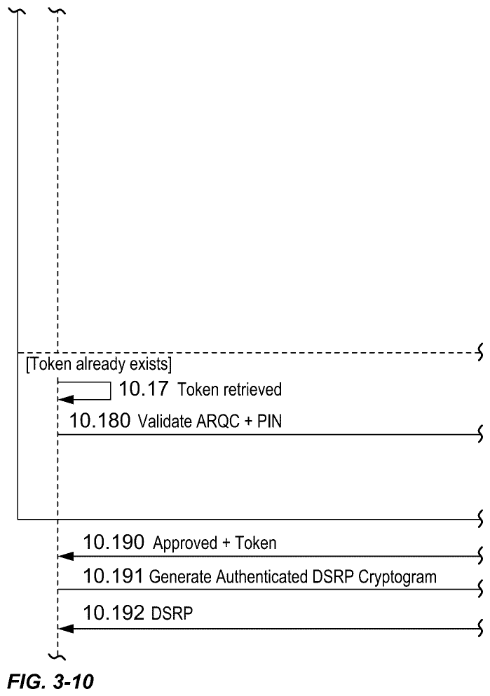

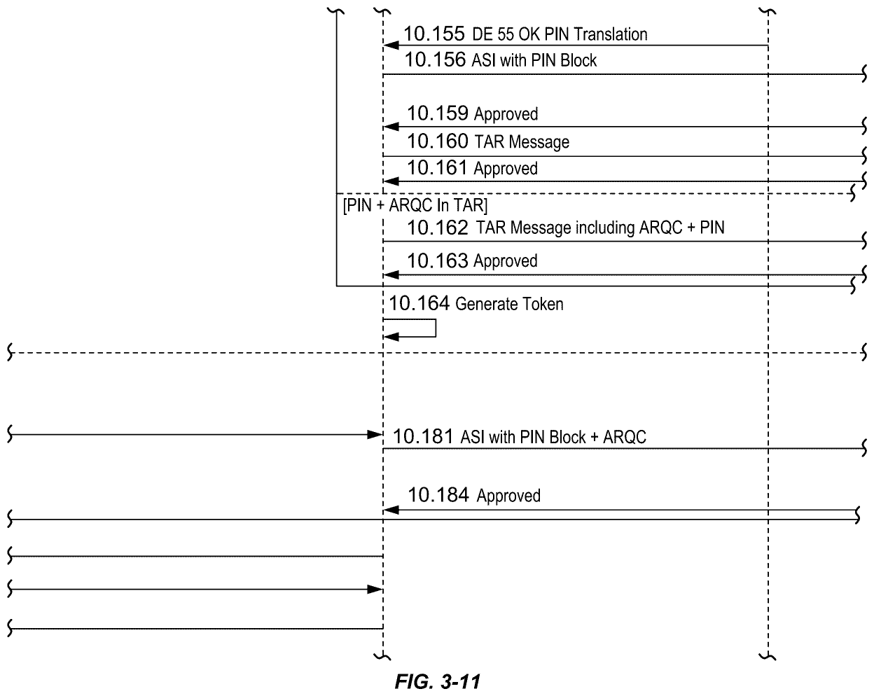

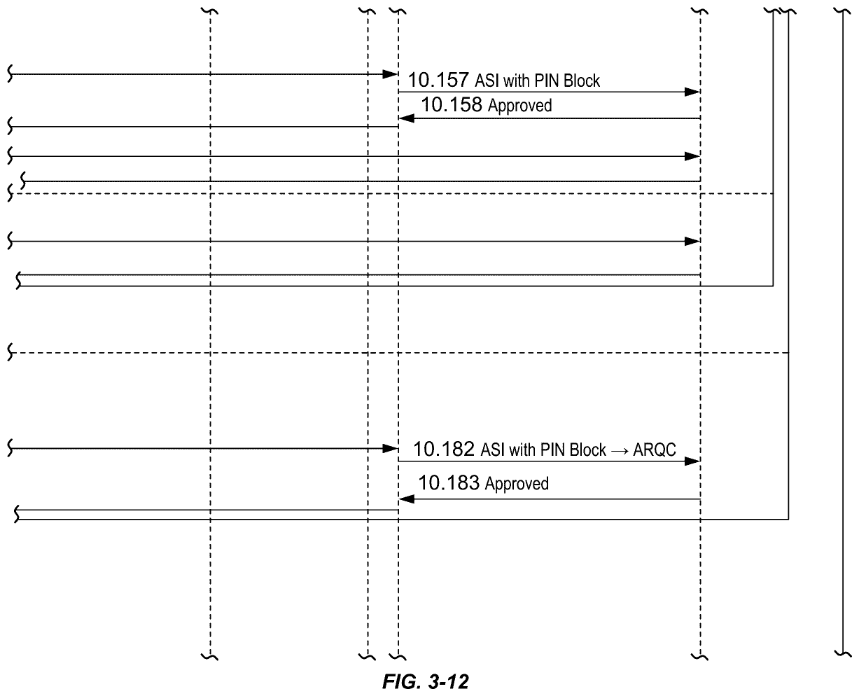

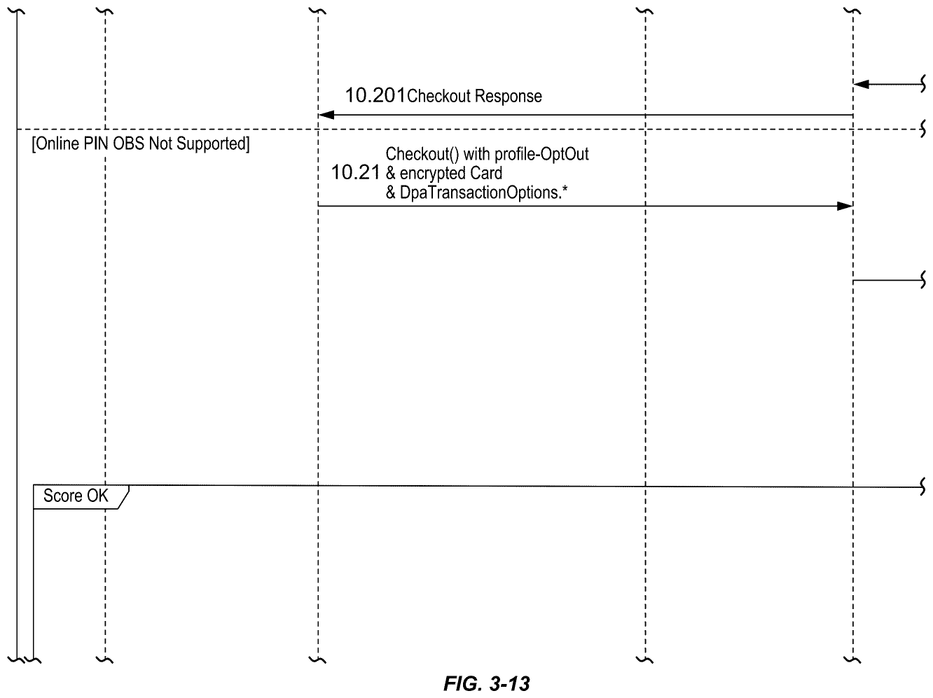

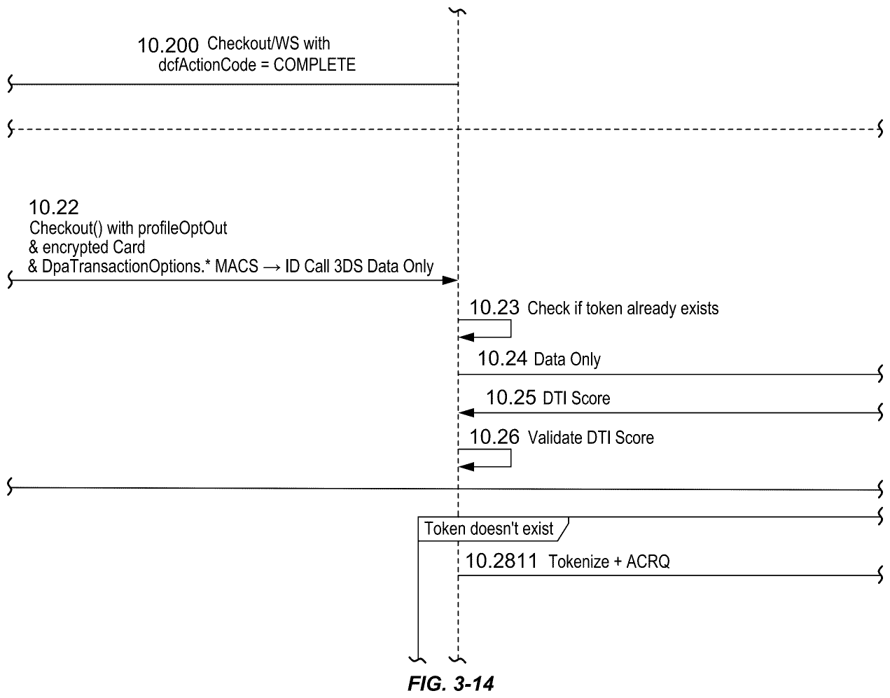

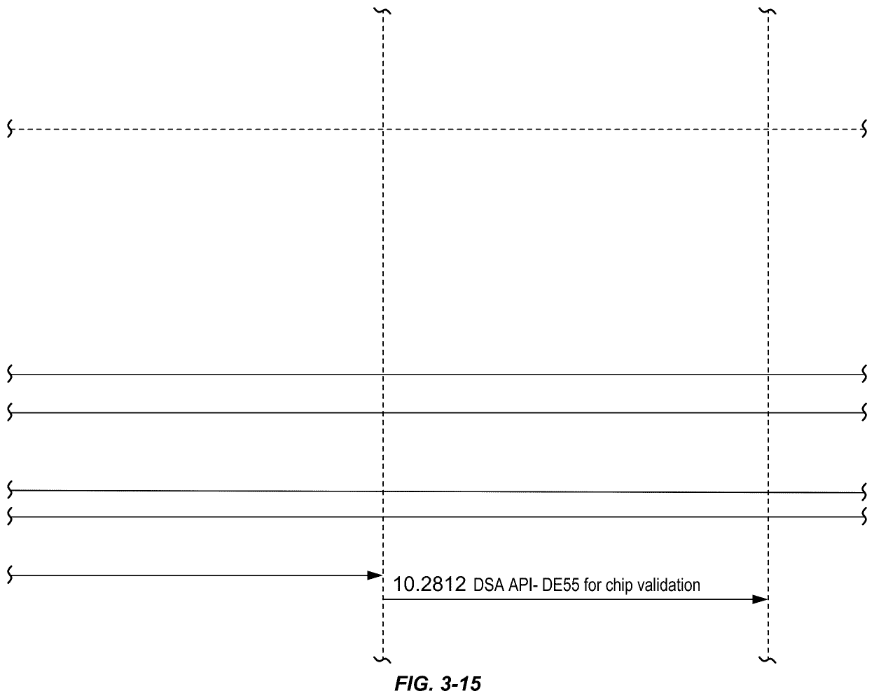

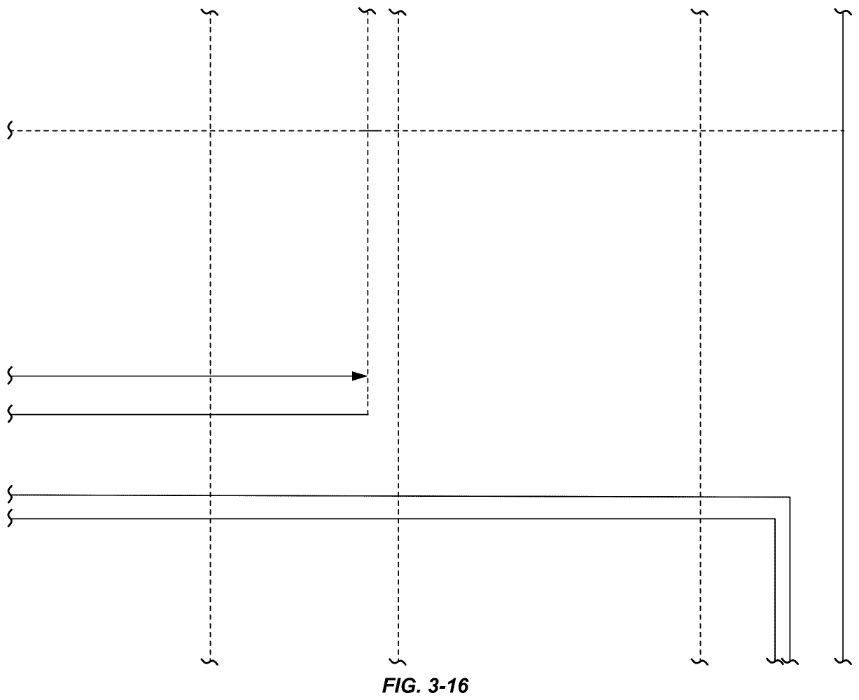

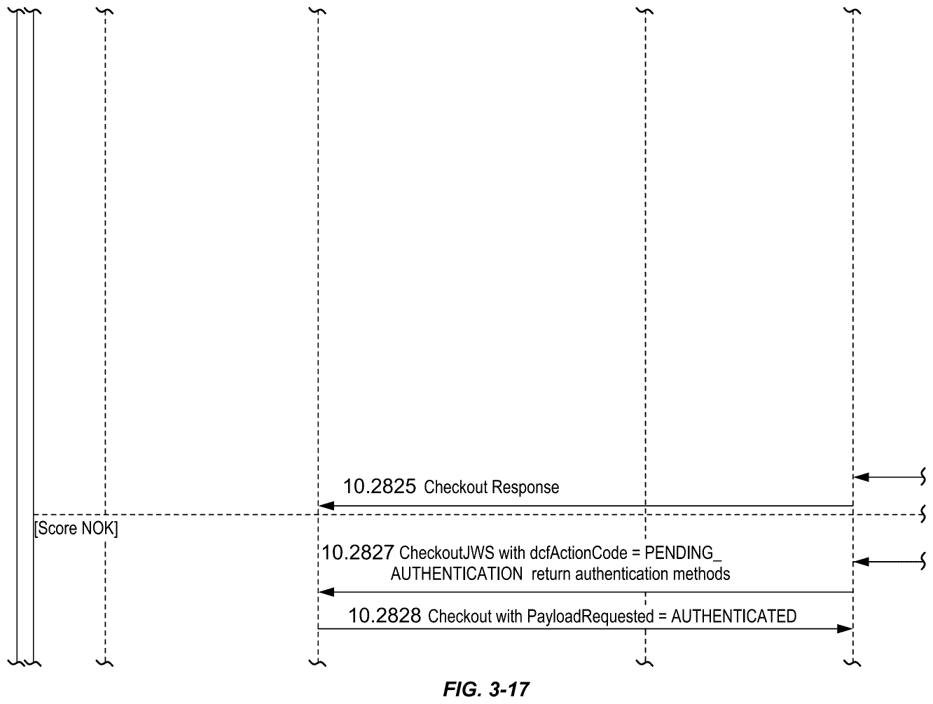

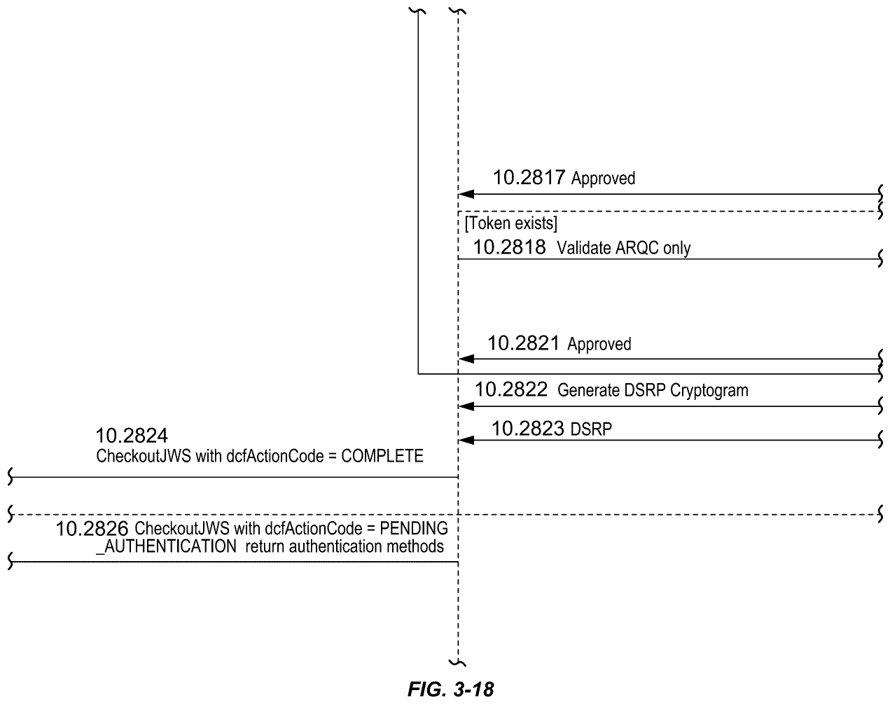

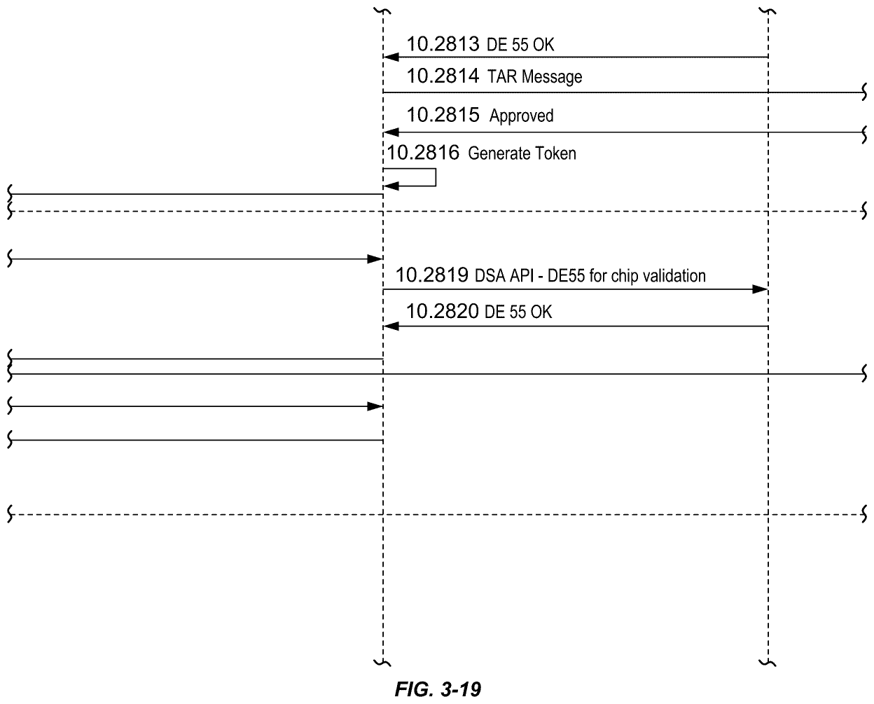

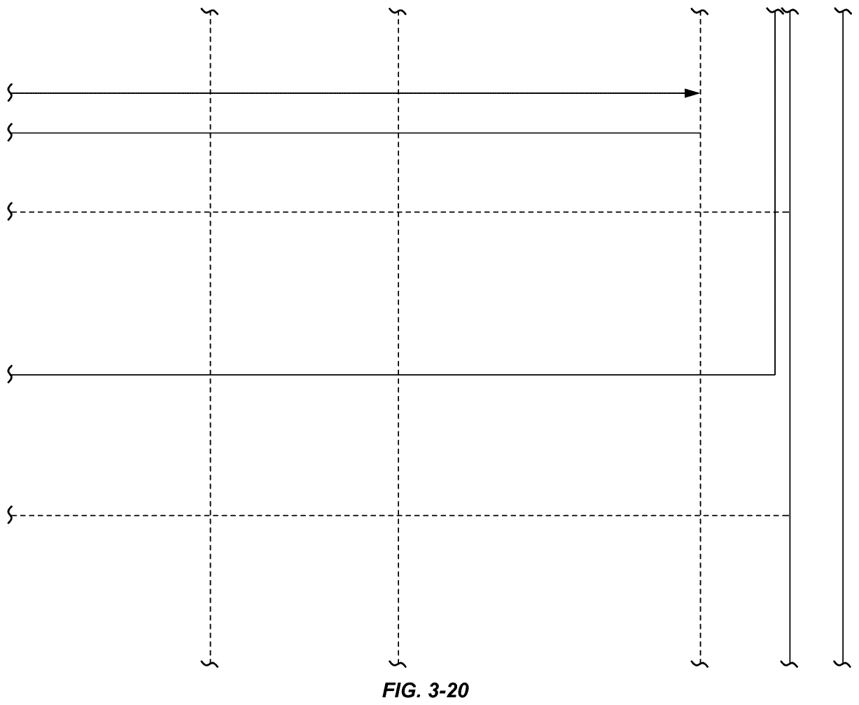

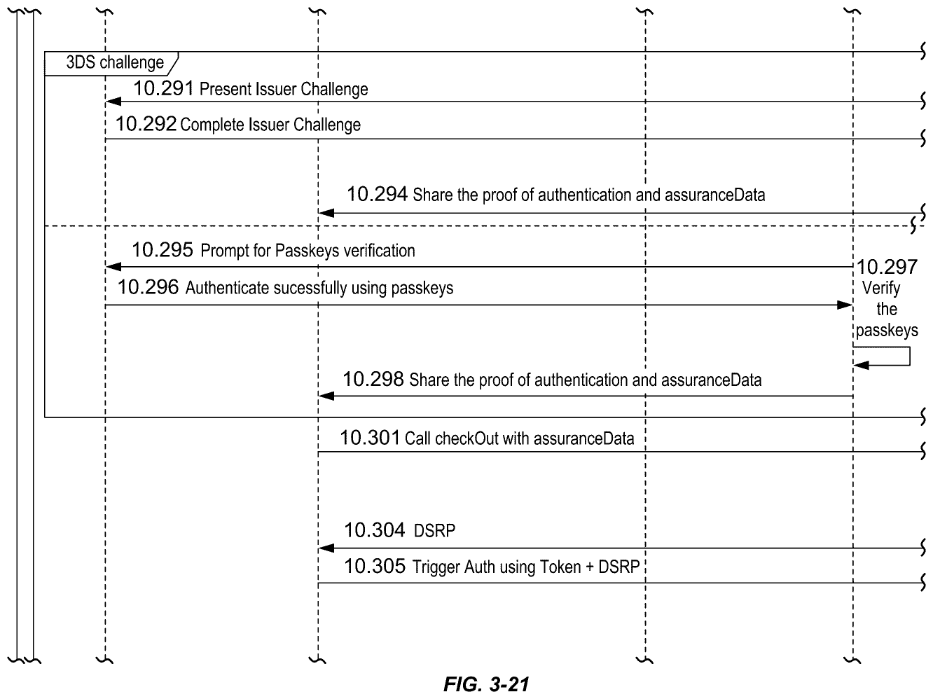

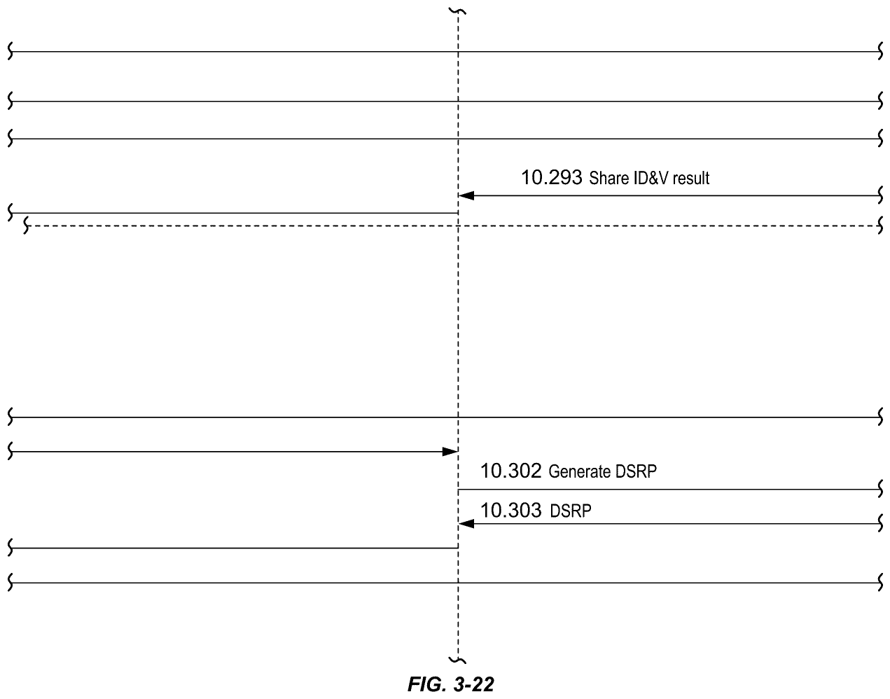

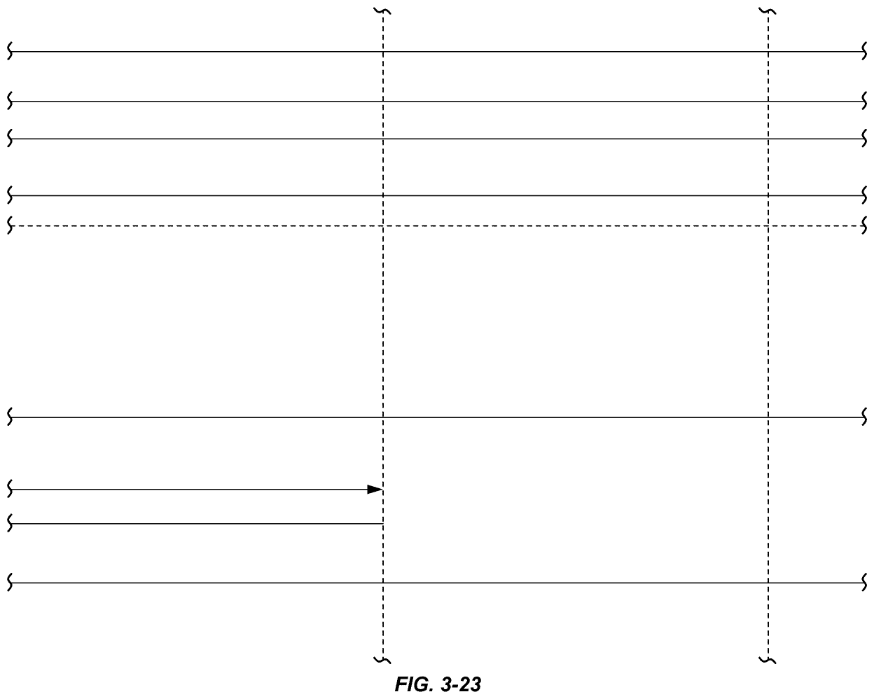

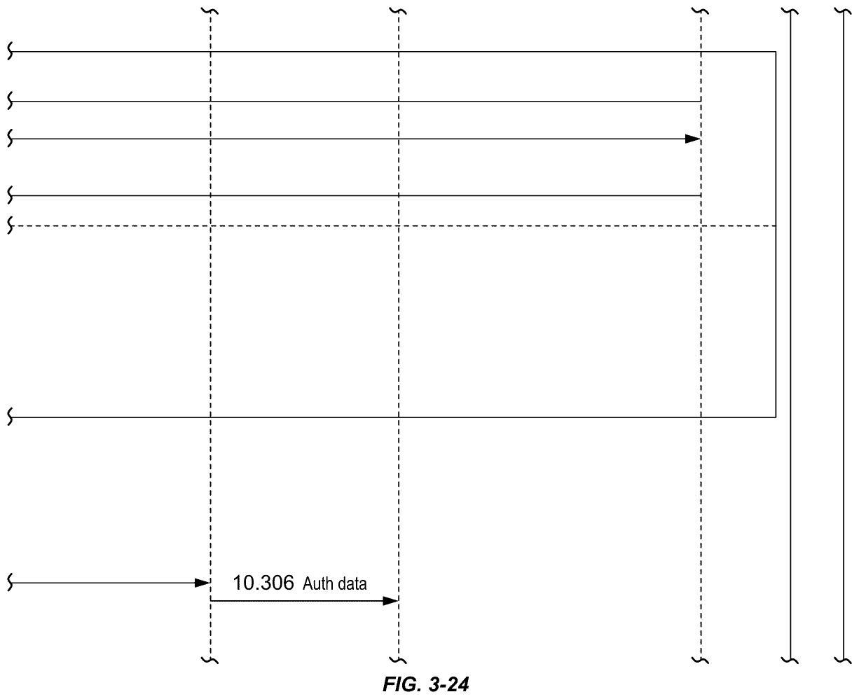

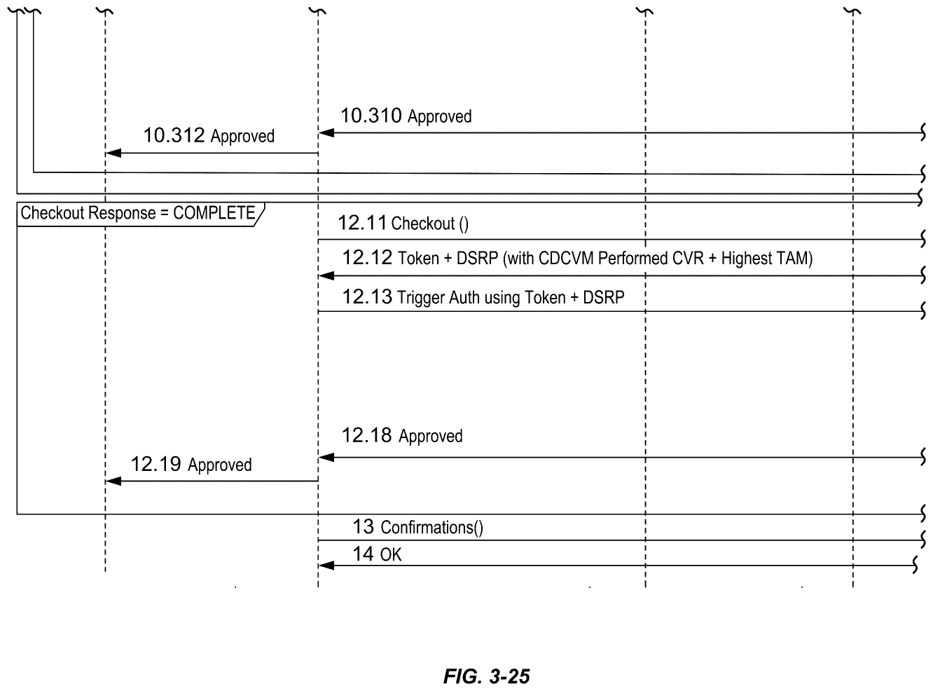

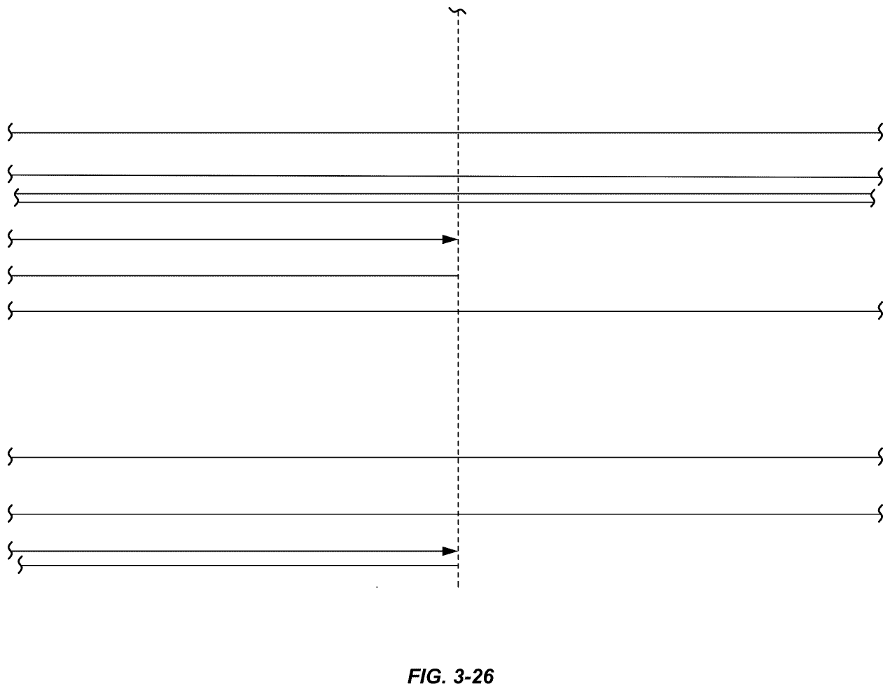

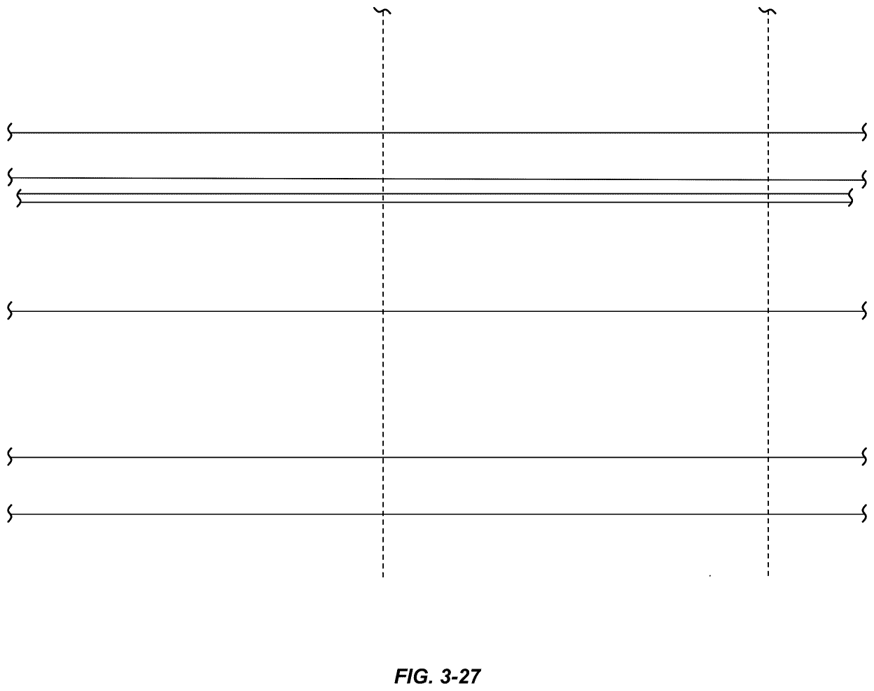

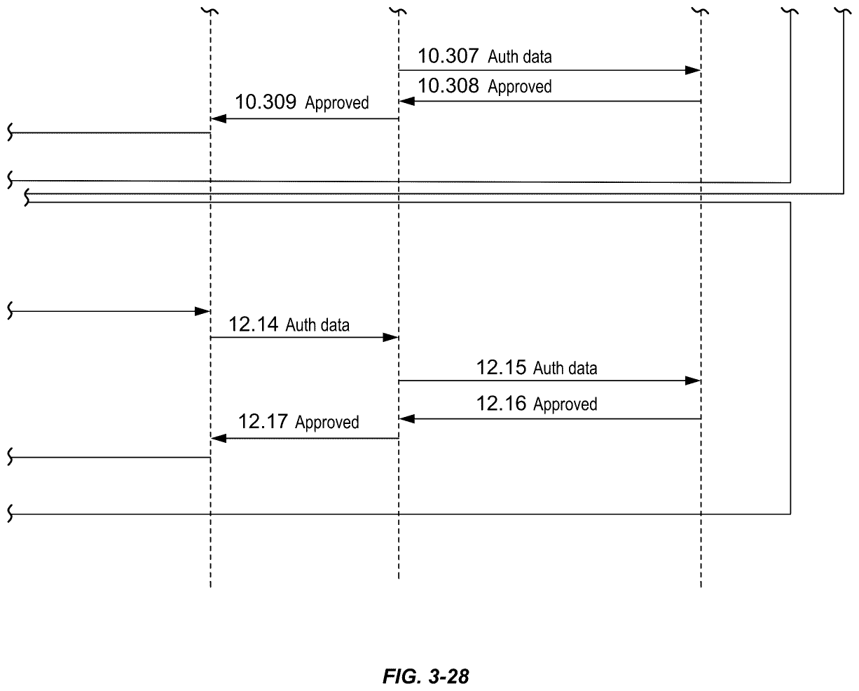

FIG. 3 illustrates an example method 300 for use in enhanced verification of a physical card of a user, at a mobile device of the user, in connection with a transaction, such as, for example, an e-commerce transaction. The example method 300 is generally described in connection with the system 100, and in conjunction with the other entities in FIG. 1. Reference is also made to the computing device 200 of FIG. 2. However, the methods herein should not be understood to be limited to the system 100 or the computing device 200, as the methods may be implemented in other systems and/or computing devices. Likewise, the systems and the computing devices herein should not be understood to be limited to the example method 300.

At the outset, it should be appreciated that the user 112 is in possession of the mobile device 110 (e.g., smartphone, etc.). The mobile device 110 is owned and operated by the user 112, which means it is not a device of the first party 102 (e.g., a mobile POS device, etc.). What's more, the user 112 is not generally located at the first party 102, but even if located at the first party 102, interacts with the first party 102, via the merchant application 114 installed at the mobile device 110 and not directly, physically with the first party 102 (or mobile POS terminal of/at the first party 102, or other POS terminal thereof, etc.) (i.e., as if not present at the first party 102).

In addition, it should also be appreciated that various interactions and/or communications are described herein as taking place within the processing network 106. In connection therewith, it should be appreciated that the various interactions and/or communications may be based on (and/or may be taking place between) different services supported by the processing network 106 (e.g., the processing network 106 in general, a tokenization service, a passkey service, or potentially, the service platform 124, etc.) and which are hosted by one or more of the same computing devices, or by different computing devices, located in the same, or different, geographic locations (but collectively referenced herein as the processing network 106).

That said, the user 112 selects a product for purchase from the first party 102, via the merchant application 114, at the mobile device 110. The user 112 further selects, at 1 in method 300, to checkout via the NFC-enabled physical card 122 of the user 112, which may be referred to as “tap to pay.” In response, the mobile device 110 (and in particular, the merchant application 114) initiates the NFC SDK 118 in the mobile device 110, at 2, which prompts the user 112 to tap the physical card 122 on the mobile device 110 (e.g., smartphone, etc.), at 3.

It should be understood that tap may include merely bringing the physical card 122 within the NFC range of the mobile device 110 whereby an actual “tap” of the physical card 122 on the mobile device 110 is not required. Generally, however, given the common form factor of the mobile device 110 (e.g., a smartphone, etc.), the physical card 122 will not be dipped or inserted into the mobile device 110.

That said, the user 112 taps, at 4, the physical card 122 on (or near) the mobile device 110.

At 5, the mobile device 110 (as caused by the NFC SDK 118) exchanges card data with the physical card 122, and in this example, identifies the physical card 122, from the card data, as being a MA or Mastercard account card. That is, for example, the mobile device 110 provides certain data (e.g., transaction amount, terminal identifier, currency code, country code, date/time, transaction type, unpredictable number, etc.), whereupon the physical card 122 generates a transaction cryptogram (e.g., an EMV Authorization Request Cryptogram (ARQC), etc.) (e.g., based on at least a portion of the data from the mobile device 110) and provides the same as part of data designated as DE55 to the mobile device 110. In addition, the mobile device 110 (as caused by the NFC SDK 118) determines whether the physical card 122 supports online PIN, at 6.

When the online PIN is supported, the mobile device 110 (as caused by the NFC SDK 118) solicits, at 7.1.1, an online PIN from the user 112, and at 7.1.2, the user 112 enters the online PIN to the mobile device 110. In response, the mobile device 110 (as caused by the NFC SDK 118) creates a PIN block, at 7.1.3, based on a public key associated with the processing network 106, and shares the PIN block with the merchant application 114, along with the DE55 data (e.g., application cryptogram, unpredictable number, counter, terminal verification result (TVR), transaction date, transaction type, transaction amount, etc.), at 7.1.4.

Conversely, when the online PIN is not supported, the mobile device 110 (as caused by the NFC SDK 118) submits the DE55 data, at 7.2.1, to the merchant application 114 and, in turn, the mobile device 110 (as caused by the merchant application 114) compiles and/or prepares merchant 3DS data, at 7.2.2. The 3DS data may include, for example, details associated with the mobile device 110 (e.g., IP address, location, phone number, etc.), which are indicative of the specific transaction (i.e., for comparison to other transactions).

Subsequently, as shown in FIG. 3, the mobile device 110 proceeds with checkout. At 8, the mobile device 110 (as caused by the merchant application 114) initiates the checkout with the service SDK 120, which responds with a successful initiation, at 9. Then, at 10.11 (when online PIN is supported), the mobile device 110 (as caused by the merchant application 114) submits the DE55 data along with the PIN block to the service SDK 120 in a request for encryption. The mobile device 110 (as caused by the service SDK 120) encrypts the DE55 data and the PIN block into encrypted card data, and returns the same to the merchant application 114, at 10.12.

The mobile device 110 (as caused by the merchant application 114) submits a checkout request to the service SDK 120, at 10.13. In this example, there is no profile created for the physical card 122 (e.g., no click-to-pay (C2P) profile, etc.). As such, a form of “guest” checkout is employed, whereby there is an opt out for the profile. The mobile device 110 (as caused by the service SDK 120) submits, at 10.14, the checkout request to the service platform 124. In response, the service platform 124 checks, at 10.15, whether a token exists for the account (e.g., based on the encrypted data, etc.).

When the check reveals that a network token does not exist, the service platform 124 submits, at 10.16, a tokenization request with the ARQC and the PIN block to a tokenization service (e.g., MASTERCARD digital enablement service (MDES), etc.), for instance, at (or as part of) the processing network 106. In turn, when PIN on-behalf service (OBS) is supported (e.g., the processing network 106 is enabled to validate the PIN, etc.), the tokenization service calls, at 10.151, a DSA API of the processing network 106, with the encrypted data. In this exemplary embodiment, the DAS API is associated with direct service access (DSA), which is the API layer for Mastercard Value Added Services (VAS).

In turn, the processing network 106 decrypts and validates both the DE55 and the PIN block, from the encrypted card data, and responds to the tokenization service, at 10.152. The PIN block is validated, for example, by decrypting the PIN block with a private key of the processing network 106, which corresponds to the public key used by the mobile device at step 7.1.3, and comparison to a card verification value. The tokenization service then submits, at 10.153, a token authorization request (TAR) message (indicating the PIN and DE 55 validations) to the issuer 108. The issuer 108, in this example embodiment, responds to the tokenization service with an approval for tokenization of the account, at 10.154.

When the PIN OBS is not supported, the processing network 106 validates the DE55 from the encrypted data, translates the PIN block from network keys (i.e., via the private key of the processing network 106, which corresponds to the public key used by the mobile device 110 at step 7.1.3) and/or (or to) issuer keys (e.g., one of a key pair shared with the issuer 108 to enable the issuer 108 to decrypt, etc.), and responds to the tokenization service, at 10.155. Based thereon, the tokenization service of the processing network 106 submits, to the processing network 106 (e.g., via the payment rails thereof, etc.) an account status inquiry (ASI), at 10.156, which in turn is submitted to the issuer 108, at 10.157. The ASI includes the translated PIN block, and, in this example, is consistent with the ISO 8583 standard protocol. In turn, the issuer 108 validates the translated PIN block and submits an approval, (or potentially, a decline), based on the PIN block being validated, or not, to the ASI, to the processing network 106, at 10.158. The approval, or decline, is passed back from the processing network 106 to the tokenization service, at 10.159.

In response to the approval, the tokenization service then submits, at 10.160, a token authorization request (TAR) message (indicating the DE 55 validation and the ASI approval for the PIN) to the issuer 108. The issuer 108, in this example embodiment, responds with an approval for tokenization of the account, at 10.161.

Where PIN OBS is not supported and there is no validation by the service platform 124 (e.g., where the embodiment includes the ARQC+PIN being validated by the issuer 108, etc.), the tokenization service of the processing network 106 submits, at 10.162, a token authorization request (TAR) message (including the ARQC and the PIN block (or the translated PIN block consistent with steps 10.152 above)) to the issuer 108. The issuer 108, in this example embodiment, performs validation of the same and further responds with an approval for tokenization of the account, at 10.163. That is, with respect to validation, specifically, in this example, the issuer 108 is in possession of private keys used to encrypt both ARQC and the PIN. The privates keys may be separate keys, or the same key. The issuer 108 decrypts the AQCR, and data included therein is validated based on consistency (e.g., PAN, expiration date, application counter, etc.) and is also assessed based on other factors. Further, the issuer 108 inputs the PIN to the HSM (hardware security module), which generates a PIN verification value (PVV), which the issuer 108 then compares with a PVV value stored in memory thereof. Based on the above, the issuer 108 responds with the approval.

In response, the tokenization service of the processing network 106 generates, at 10.164, a network token for the account.

Conversely, when a network token exists for the account, at 10.15, the service platform 124 initiates a retrieval of the network token for the account, at 10.17, whereby the service platform 124 submits, at 10.180, a request for the token along with the ARQC and the PIN block to validate the request, to the tokenization service of the processing network 106. The tokenization service submits, to the processing network 106 (e.g., via the payment rails thereof, etc.) an account status inquiry (ASI), at 10.181, which in turn is submitted to the issuer 108, at 10.182. The ASI includes the ARQC and the PIN block (i.e., translated PIN block, as explained above), and, in this example, is consistent with the ISO 8583 standard protocol. In turn, the issuer 108 validates the ARQC and the PIN block and submits, at 10.183, an approval, (or potentially, a decline), based on the PIN block being validated, or not, to the ASI, to the processing network 106. The approval, or decline, is passed back, at 10.184, from the processing network 106 to the tokenization service (e.g., as part of the processing network 106, etc.).

In response to the approval (e.g., from step 10.163 or 10.184, the tokenization service passes, at 10.190, the approval from the issuer 108 and the network token for the account to the service platform 124.

Also, the service platform 124 submits, at 10.191, a request to generate an authenticated DSRP cryptogram, to the tokenization service of the processing network 106. In response, the tokenization service generates and returns, at 10.192, the DSRP cryptogram. The service platform 124 then submits a checkout response to the mobile device 110, which indicates that the status of the checkout is complete, at 10.200. The checkout request includes the token and the DSRP cryptogram, which, in turn, includes the appropriate flags to indicate the cardholder verification method and token authentication method performed for the transaction. The completion, in this context, indicates to the mobile device 110 that the card authentication was successful and the token and DSRP were created successfully and are ready for use.

The mobile device 110 (as caused by the service SDK 120) returns the checkout response to the merchant application 114, at 10.201.

Alternatively, when online PIN is not supported, the mobile device 110 (as caused by the merchant application 114) submits, at 10.21, a checkout request with the encrypted card data to the initiated service SDK 120. The checkout request includes a parameter which indicates the transaction options, such as, for example, 3DS data or a type of DSRP Cryptogram returned. The mobile device 110 (as caused by the service SDK 120) submits, at 10.22, the checkout request to the service platform 124. In response, the service platform 124 determines, at 10.23, whether a token exists for the account.

Next, at 10.24, the service platform 124 calls one or more services of the processing network 106 with the 3DS data only from the checkout request. The processing network 106, in turn, elevates the 3DS data and responds, at 10.25, with an accountholder authentication value (AAV), along with a digital transaction insight (DTI) score, to the service platform 124. The evaluation for the 3DS data may include a comparison of the 3DS data to other transactions associated with the physical card 122, the user 112, etc. For example, the IP address from which the transaction is initiated (e.g., associated with the mobile device 110, etc.) may match the IP address used in a number of prior transactions. As such, in this specific example, the consistency of the 3DS data with prior transactions defines the DTI score for the transaction. Next, at 10.26, The service platform 124 validates the DTI score relative to one or more defined thresholds.

When the score is validated and the network token does not exist, the service platform 124 submits, at 10.2811, a tokenization request with the ARQC to the tokenization service (e.g., MASTERCARD digital enablement service (MDES), etc.) of the processing network 106. In turn, the tokenization service calls, at 10.2812, a DSA API of the processing network 106, with the ARQC and the DE 55 data. The processing network 106 decrypts (if needed) and validates the DE 55 data, and responds to the tokenization service, at 10.2813. The tokenization service then submits, at 10.2814, a token authorization request (TAR) message (indicating the DE 55 validation) to the issuer 108. The issuer 108, in this example embodiment, responds with an approval for tokenization of the account, at 10.2815. The tokenization service generates, at 10.2816, a network token for the account, and further provides the approval back to the service platform 124, at 10.2817.

When the score is validated and the network token exists, the service platform 124 submits, at 10.2818, a request for the token along with the ARQC to validate the request, to the tokenization service of the processing network 106. The tokenization service calls, at 10.2819, a DSA API of the processing network 106, with the ARQC and the DE 55 data. The processing network 106 decrypts (if needed) and validates the DE 55 data, and responds to the tokenization service, at 10.2820. The tokenization service then provides the approval back to the platform 124, at 10.2821, along with the token.

Also, the service platform 124 submits, at 10.2822, a request to generate an authenticated DSRP cryptogram, to the tokenization service of the processing network 106. In response, the tokenization service generates and returns, at 10.2823, the DSRP cryptogram. The service platform 124 then submits a checkout response to the mobile device 110, which indicates that the status of the checkout is complete, at 10.2824. The checkout request includes the token and the DSRP cryptogram, which, in turn, includes the appropriate flags to indicate the cardholder verification method and token authentication method performed for the transaction. The completion, in this context, indicates to the mobile device 110 that the card authentication was successful and the token and DSRP were created successfully and are ready for use.

The mobile device 110 (as caused by the service SDK 120) returns the checkout response to the merchant application 114, at 10.2825.

When the score is not validated, the service platform 124 submits a checkout response to the mobile device 110, which indicates that the status of the checkout is pending authentication, at 10.2826. In addition, the available authentication methods are provided, including specifically, a 3DS challenge.

In response, the mobile device 110 (as caused by the service SDK 120) returns the checkout response to the merchant application 114, at 10.2827. In turn, the mobile device 110 (as caused by the merchant application 114) connects the cardholder to the issuer 108 (e.g., 3DS provider associated therewith, etc.), through the SDK 120, at 10.2828. That is, the mobile device 110 (as caused by the SDK 120) initiates a challenge for purposes of authentication. In the method 300, the authentication methods include 3DS challenge, and also passkey authentication. It should be appreciated that other forms of authentication may be initiated from the mobile device 110 (e.g., by either the merchant application 114 and/or the SDK 120, etc.).

As shown in FIG. 3, the issuer 108 presents, at 10.291, an issuer challenge to the cardholder, at the mobile device 110. The challenge may include a phone call, text message, or interaction with the mobile device 110 based on an issuer application in the mobile device 110, etc. Consistent, the challenge may include a one-time-passcode (OTP), or link, etc., whereupon the cardholder completes the authentication challenge, at 10.292, with the issuer 108.

The issuer 108 then performs an identification and verification (ID &V) sequence, whereupon the issuer 108 attains a confidence that the cardholder is associated with the account. The result of the ID&V is provided from the issuer 108 to the service platform 124, at 10.293. Then, at 10.294, the service platform 124 shares the proof of authentication (e.g., at least a portion of the ID&V result, etc.) and assurance data to the mobile device 110, and specifically, the merchant application 114.

Alternatively, rather than the 3DS challenge, the mobile device 110 (as caused by the service SDK 120) initiates passkey verification with the cardholder, at 10.295. In response, the cardholder is biometrically authenticated at the mobile device 110, at 10.296, which permits access to the passkey therein. The mobile device 110 (as cased by the service SDK 120) verifies the passkey, at 10.297. That is, the passkey service of the processing network 106 (or potentially, of the service platform 124) may provide a challenge in response to the service SDK 120, whereby the mobile device 110 (as caused by the service SDK 120) authenticate the user 112 and then signs the challenge with the passkey. The mobile device 110 (as caused by the service SDK 120) returns the signed challenge to the passkey service, which verifies the signature on the challenge and confirms the same to the mobile device 110 by way of a proof of authentication and, potentially, assurance data associated with the authentication. In this way, then, the user 112 is authenticated. As a result, at 10.298, the mobile device 110 (as caused by the service SDK 120) shares the proof of authentication and assurance data to the mobile device 110, and specifically, the merchant application 114.

As shown in FIG. 3, at 10.301, the mobile device (as caused by the merchant application 114) calls the checkout API from the service platform 124 with the assurance data from the authentication of the cardholder (e.g., 3DS challenge, passkey, etc.). The platform 124, in turn, submits, at 10.302, a request to generate an authenticated DSRP cryptogram, to the tokenization service of the processing network 106. In response, the tokenization service of the processing network 106 generates and returns, at 10.303, the DSRP cryptogram and token. Subsequently, the service platform 124 then submits the DSRP cryptogram and the token to the mobile device 110, at 10.304.

The mobile device 110 (as caused by the merchant application 114) triggers, at 10.305, authentication of the DSRP cryptogram and the token for the account, with the acquirer 104. The acquirer 104, in turn, submits, at 10.306, the authentication data to the processing network 106, which submits, at 10.307, the authentication data to the issuer 108. The issuer verifies the authentication data and returns, at 10.308, as appropriate, an approval (indicating the authentication data is verified). The processing network 106 then provides the approval back to the acquirer 104, at 10.309. The approval is then submitted by the acquirer 104 to the mobile device 110, at 10.310. The approved status for the tokenization/transaction is displayed to the cardholder, by the mobile device 110, at 10.312.

Thereafter, the mobile device 110 (as caused by the merchant application 114, or service SDK 120, depending on the first party integration) initiates, at 12.11, checkout with the service platform 124 (or potentially, the application backend 116). In doing so, the service platform 124 provides, at 12.12, the network token and the DSRP cryptogram (which include flags for CDCVM (Consumer Device Cardholder Verification Method) performed CVR (Card Verification Value) and the highest TAM (Token Assurance Method)). In this way, the network token and the DSRP cryptogram define the particular verification associated with the transaction, which is based on the cryptogram transmitted/transferred from the physical card 122 to the mobile device 110, the Online PIN, the 3DS data, etc.

Next, the mobile device 110 (as configured by the merchant application 114) initiates, at 12.13, through the application backend 116 (not shown), authorization of the transaction with the network token and the DSRP cryptogram, with the acquirer 104. The acquirer 104 submits, at 12.14, the authorization request for the transaction to the processing network 106. The processing network 106 passes, at 12.15, the authorization request to the issuer 108. The issuer 108 approves (or declines) authorization, at 12.16, based on the token and DSRP cryptogram, among other things, and provides an authorization response back to the processing network 106. The processing network 106 passes the authorization response to the acquirer 104, at 12.17.

The acquirer 104 provides the authorization response to the application backend 116, which passes the authorization response, or indication thereof, to the mobile device 110, at 12.18. The mobile device 110 (as caused by the merchant application 114) notifies, at 12.19, the user 112 of the approval (or decline). Finally, at 13, the mobile device 110 confirms the approved transaction (or declined transaction) to the service platform 124, which acknowledges the approved (or declined) transaction, at 14.

In view of the above, the systems and methods herein provide enhanced verification of a physical card of a user, at a mobile device of the user (i.e., the user's own device (e.g., belonging to the user, and not to a merchant)), in connection with a transaction, such as, for example, an e-commerce transaction. More specifically, since the introduction of mobile POS terminals at merchants, the inventors hereof have envisioned extending the function to establish an easier and faster way for the users to initiate purchase transactions from their own personal devices (e.g., not a mobile POS of the merchant). The systems and methods herein, therefore, provide for use cases to enable cardholders tapping their own card on their own mobile device to establish an authenticated transaction leveraging the contactless EMV cards security without having to type the card number manually and/or store the card on-file with the merchant.

In connection with the above, based on the physical card interacting with the mobile device (e.g., via tap, etc.), a cryptogram specific to the transaction is generated by the physical card and then validated through a service platform. The service platform also facilitates a further authentication of the user (e.g., via Online PIN, 3DS data scoring, etc.). In this way, assurance is made available for the card-not-present (CNP) transaction that a physical card and user were indeed present at the initiation of the transaction, i.e., at the mobile device (e.g., e-commerce transaction, etc.). The technical data flow defined by the service platform and the user's mobile device, simulate assurance which is similar to the user presenting his/her card physically at the location of the merchant (yet, preserving the CNP designation (i.e., transaction is not destinated card present)). In this way, transactions initiated at the mobile device of the user may become more secure.

Again, and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following operations: (a) for a transaction between a first party and a user, receiving, from a mobile device specific to a user, encrypted card data for the transaction, the encrypted card data including a cryptogram specific to the transaction; (b) validating the encrypted card data; (c) in response to the encrypted data being validated, generating a network token for the transaction; (d) responding to the encrypted data, to the mobile device specific to the user, with a complete status; and/or (e) in response to a checkout request for the transaction, returning the token to the mobile device, whereby the mobile device submits the token to the first party for authorization of the transaction.

In one embodiment, a computer-implemented method for facilitating enhanced verification of a physical card of a user, at a mobile device of the user, in connection with a transaction, the method comprises: for a transaction between a first party and a user, receiving, by a service platform computing device, from a mobile device specific to a user, encrypted card data for the transaction, the encrypted card data including a cryptogram specific to the transaction; validating, by the service platform computing device, the encrypted card data; in response to the encrypted data being validated, generating, by the service platform computing device, a network token for the transaction; responding, by the service platform computing device, to the encrypted data, to the mobile device specific to the user, with a complete status; and then, in response to a checkout request for the transaction, returning, by the service platform computing device, the token to the mobile device, whereby the mobile device submits the token to the first party for authorization of the transaction.

In a further embodiment of the above computer-implemented method, the encrypted card data includes a cryptogram generated by or in cooperation with a physical card being in near-field communication (NFC) with the mobile device. In a further embodiment of the above computer-implemented method(s), the encrypted card data includes a PIN block and validating the encrypted card data includes validating the PIN block based on a private network key specific to a processing network. In a further embodiment of the above computer-implemented method(s), the encrypted card data includes a PIN block and validating the encrypted card data includes: translating the PIN block from a private network key of the processing network to an issuer key associated with an issuer of an account to which the transaction is directed; and submitting the translated PIN block to the issuer for approval, whereby approval by the issuer is part of the validation of the encrypted card data.

In a further embodiment of the above computer-implemented method(s), the methods(s) include determining whether the network token exists, prior to generating the network token; and generating the network token is further in response to determining that the network token does not exist. In a further embodiment of the above computer-implemented method(s), the method(s) include decrypting the encrypted card data, based on a private key, prior to validating the encrypted card data.

In a further embodiment of the above computer-implemented method(s), the method(s) include receiving, by the mobile device, the cryptogram from a physical card associated with an account of the user to which the transaction is directed, based on the physical card being proximate to the mobile device; encrypting the cryptogram into the encrypted data based on a public network key specific to the mobile device; and communicating, by the mobile device, the cryptogram as part of the encrypted card data to the service platform computing device.

In a further embodiment of the above computer-implemented method(s), receiving the cryptogram from the mobile device includes receiving the cryptogram from the mobile device via near-field communication (NFC) between the mobile device and the physical card. In a further embodiment of the above computer-implemented method(s), the method(s) include determining, by the mobile device, whether PIN is supported for the account; in response to determining that PIN is supported for the account: soliciting, by the mobile device, a PIN code from the user; compiling, by the mobile device, the PIN code into a PIN block; transmitting the PIN block to the service platform computing device as part of the encrypted card data; and encrypting the PIN block with the network public key into the encrypted card data, prior to communicating the encrypted card data to the service platform computing device.

In an additional embodiment, a mobile device, specific to a user, for facilitating enhanced verification of a physical card of the user, the mobile device comprises a non-transitory storage memory including computer-executable instructions; and a processor coupled to the memory, the processor configured to execute the computer-executable instructions to cause the mobile device to: for a transaction initiated at the mobile device of the user, receive a cryptogram from a physical card, based on the physical card being proximate to the mobile device; solicit a personal identification number (PIN) from the user; receive the PIN from the user; create a PIN block based on the received PIN and a public key associated with a processing network; communicate the PIN block and the cryptogram to a service platform, whereby the service platform validates the cryptogram and PIN block and store a network token based on the validation of the cryptogram and PIN block; and retrieve, from the service platform, a network token based on the validation of the PIN block and the cryptogram.

In a further embodiment of the above mobile device(s), the processor is configured to execute the computer-executable instructions to cause the mobile device to: retrieve a second cryptogram from the service platform; and compile an authorization request for the transaction, which include the network token and a second cryptogram. In a further embodiment of the above mobile device(s), the computer-executable instructions are organized into a merchant application, which includes an NFC software development kit (SDK) and a service SDK. In a further embodiment of the above mobile device(s), the physical card being proximate to the mobile device includes the physical card being within a near-field communication (NFC) range of the mobile device.

In an additional embodiment, a non-transitory computer-readable storage medium comprising executable instructions, which when executed by at least one processor of a processing network, cause the at least one processor to: for a transaction between a first party and a user, receive, from a mobile device specific to the user, encrypted card data for the transaction, the encrypted card data including an authorization request cryptogram (ARQC) specific to the transaction; determine whether a network token exists for the transaction; when the network token does not exist for the transaction: validate the encrypted card data; based on the encrypted card data being valid, submit a token authorization request (TAR) to an issuer of an account of the user; and based on an approval, in response to the TAR, generate the network token for the transaction; when the network token does exist for the transaction: validate the ARQC with the issuer of the account; and retrieve the network token for the transaction; and in response to the approval from the issuer or the ARQC being validated by the issuer: generate a second cryptogram; and return the token and the second cryptogram to the mobile device, whereby the mobile device submits the token to the first party for authorization of the transaction.

In a further embodiment of the above medium(s), the ARQC is generated by or in cooperation with a physical card being in near-field communication (NFC) with the mobile device; and the second cryptogram is a Digital Secure Remote Payment (DSRP) cryptogram. In a further embodiment of the above medium(s), the encrypted card data includes a PIN block; and the executable instructions, when executed by the at least one processor, cause the at least one processor, in validating the encrypted card data, to validate the PIN block based on a private network key specific to the processing network. In a further embodiment of the above medium(s), the encrypted card data includes a PIN block; and the executable instructions, when executed by the at least one processor, cause the at least one processor, in validating the encrypted card data, to: translate the PIN block from a private network key of the processing network to an issuer key associated with an issuer of an account to which the transaction is directed; and submit the translated PIN block to the issuer for approval, whereby approval by the issuer is part of the validation of the encrypted card data. In a further embodiment of the above medium(s), the executable instructions, when executed by the at least one processor, cause the at least one processor to decrypt the encrypted card data, based on a private key, prior to validating the encrypted card data.

In a still further embodiment, a non-transitory computer-readable storage medium comprising executable instructions, which when executed by at least one processor of a processing network, cause the at least one processor to: for a transaction between a first party and a user, receive, from a mobile device specific to the user, encrypted data for the transaction; transmit at least a portion of the encrypted data to an issuer of an account involved in the transaction, whereby the issuer responds with a score; when the score is not valid: return an instruction to authenticate the user to the mobile device, whereby the user is authenticated through the mobile device; receive a checkout request from the mobile device, based on the user being authenticated; in response to the checkout request, generate a cryptogram specific to the transaction; and return the cryptogram and a token for the account to the mobile device, whereby the mobile device initiates authentication of the user based on the cryptogram and the token.

In a further embodiment of the above medium, the authentication at the mobile device includes a 3DS challenge or a passkey authentication.

In various embodiment, a mobile device, specific to a user, for facilitating enhanced verification of a physical card of the user, the mobile device comprising: a non-transitory storage memory including computer-executable instructions; and a processor coupled to the memory, the processor configured to execute the computer-executable instructions to cause the mobile device to: for a transaction initiated at the mobile device of the user through a physical card, and based on an online PIN not being supported for the physical card; initiating a software-development kit (SDK); based on the initiated SDK, transmit encrypted card data for the transaction to a service platform, whereby a score is generated for the transaction, the encrypted card data including a cryptogram specific to the transaction; based on the score being invalid relative to a threshold, authenticate the user, wherein the authentication of the user is indicated by assurance data; submit the assurance data to the service platform; receive, from the service platform, based on the authentication, a second cryptogram and a token for an account of the user; and submit the second cryptogram and the token to an issuer of the account for approval to proceed with the transaction.

In a further embodiment of the above mobile device(s), the processor is configured to execute the computer-executable instructions to cause the mobile device to authenticate the user through a passkey authentication, by: requesting a challenge from a passkey service; soliciting a biometric from the user; authenticating the biometric from the user based on a reference biometric to access a private key in the memory of the mobile device; in response to a challenge from the passkey service, sign the challenge and return the signed challenge to the passkey service, whereby the passkey service provides the assurance data to the mobile device.

In a further embodiment of the above mobile device(s), the processor is configured to execute the computer-executable instructions to cause the mobile device to authenticate the user through a 3DS challenge, by: receiving a challenge question from the issuer/ACS of the issuer for the account; soliciting a response from the user to the challenge question; and submitting the response from the user to the issuer/ACS of the issuer, in response to receiving the challenge question, whereby the issuer/ACS of the issuer provides the assurance data to the mobile device.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art, that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only, and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” includes any and all combinations of one or more of the associated listed items.

In addition, as used herein, the term product may include a good and/or a service.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

None of the elements recited in the claims are intended to be a means-plus-function element within the meaning of 35 U.S.C. § 112 (f) unless an element is expressly recited using the phrase “means for,” or in the case of a method claim using the phrases “operation for” or “step for.”

The foregoing description of example embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for facilitating enhanced verification of a physical card of a user, at a mobile device of the user, in connection with a transaction, the method comprising:
for a transaction between a first party and a user, receiving, by a service platform computing device, from a mobile device specific to a user, encrypted card data for the transaction, the encrypted card data including a cryptogram specific to the transaction;
validating, by the service platform computing device, the encrypted card data;
in response to the encrypted data being validated, generating, by the service platform computing device, a network token for the transaction;
responding, by the service platform computing device, to the encrypted data, to the mobile device specific to the user, with a complete status; and then,
in response to a checkout request for the transaction, returning, by the service platform computing device, the token to the mobile device, whereby the mobile device submits the token to the first party for authorization of the transaction.

2. The computer-implement method of claim 1, wherein the encrypted card data includes a cryptogram generated by or in cooperation with a physical card being in near-field communication (NFC) with the mobile device.

3. The computer-implement method of claim 2, wherein the encrypted card data includes a PIN block; and
wherein validating the encrypted card data includes validating the PIN block based on a private network key specific to a processing network.

4. The computer-implement method of claim 3, wherein the encrypted card data includes a PIN block; and
wherein validating the encrypted card data includes:
translating the PIN block from a private network key of the processing network to an issuer key associated with an issuer of an account to which the transaction is directed; and
submitting the translated PIN block to the issuer for approval, whereby approval by the issuer is part of the validation of the encrypted card data.

5. The computer-implement method of claim 1, further comprising:
determining whether the network token exists, prior to generating the network token; and
wherein generating the network token is further in response to determining that the network token does not exist.

6. The computer-implemented method of claim 1, further comprising decrypting the encrypted card data, based on a private key, prior to validating the encrypted card data.

7. The computer-implement method of claim 1, further comprising:
receiving, by the mobile device, the cryptogram from a physical card associated with an account of the user to which the transaction is directed, based on the physical card being proximate to the mobile device;
encrypting the cryptogram into the encrypted data based on a public network key specific to the mobile device; and
communicating, by the mobile device, the cryptogram as part of the encrypted card data to the service platform computing device.

8. The computer-implement method of claim 7, wherein receiving the cryptogram from the mobile device includes receiving the cryptogram from the mobile device via near-field communication (NFC) between the mobile device and the physical card.

9. The computer-implement method of claim 7, further comprising:
determining, by the mobile device, whether PIN is supported for the account;
in response to determining that PIN is supported for the account:
soliciting, by the mobile device, a PIN code from the user;
compiling, by the mobile device, the PIN code into a PIN block;
transmitting the PIN block to the service platform computing device as part of the encrypted card data; and
encrypting the PIN block with the network public key into the encrypted card data, prior to communicating the encrypted card data to the service platform computing device.

10. A mobile device, specific to a user, for facilitating enhanced verification of a physical card of the user, the mobile device comprising:
a non-transitory storage memory including computer-executable instructions; and
a processor coupled to the memory, the processor configured to execute the computer-executable instructions to cause the mobile device to:
for a transaction initiated at the mobile device of the user, receive a cryptogram from a physical card, based on the physical card being proximate to the mobile device;
solicit a personal identification number (PIN) from the user;
receive the PIN from the user;
create a PIN block based on the received PIN and a public key associated with a processing network;
communicate the PIN block and the cryptogram to a service platform, whereby the service platform validates the cryptogram and PIN block and store a network token based on the validation of the cryptogram and PIN block; and
retrieve, from the service platform, a network token based on the validation of the PIN block and the cryptogram.

11. The mobile device of claim 10, wherein the processor is configured to execute the computer-executable instructions to cause the mobile device to:
retrieve a second cryptogram from the service platform; and
compile an authorization request for the transaction, which include the network token and a second cryptogram.

12. The mobile device of claim 11, wherein the computer-executable instructions are organized into a merchant application, which includes an NFC software development kit (SDK) and a service SDK.

13. The mobile device of claim 11, wherein the physical card being proximate to the mobile device includes the physical card being within a near-field communication (NFC) range of the mobile device.

14. A non-transitory computer-readable storage medium comprising executable instructions, which when executed by at least one processor of a processing network, cause the at least one processor to:
for a transaction between a first party and a user, receive, from a mobile device specific to the user, encrypted card data for the transaction, the encrypted card data including an authorization request cryptogram (ARQC) specific to the transaction;
determine whether a network token exists for the transaction;
when the network token does not exist for the transaction:
validate the encrypted card data;
based on the encrypted card data being valid, submit a token authorization request (TAR) to an issuer of an account of the user; and
based on an approval, in response to the TAR, generate the network token for the transaction;
when the network token does exist for the transaction:
validate the ARQC with the issuer of the account; and
retrieve the network token for the transaction; and
in response to the approval from the issuer or the ARQC being validated by the issuer:
generate a second cryptogram; and
return the token and the second cryptogram to the mobile device, whereby the mobile device submits the token to the first party for authorization of the transaction.

15. The non-transitory computer-readable storage medium of claim 14, wherein the ARQC is generated by or in cooperation with a physical card being in near-field communication (NFC) with the mobile device; and
wherein the second cryptogram is a Digital Secure Remote Payment (DSRP) cryptogram.

16. The non-transitory computer-readable storage medium of claim 15, wherein the encrypted card data includes a PIN block; and
wherein the executable instructions, when executed by the at least one processor, cause the at least one processor, in validating the encrypted card data, to validate the PIN block based on a private network key specific to the processing network.

17. The non-transitory computer-readable storage medium of claim 15, wherein the encrypted card data includes a PIN block; and
wherein the executable instructions, when executed by the at least one processor, cause the at least one processor, in validating the encrypted card data, to:
translate the PIN block from a private network key of the processing network to an issuer key associated with an issuer of an account to which the transaction is directed; and
submit the translated PIN block to the issuer for approval, whereby approval by the issuer is part of the validation of the encrypted card data.

18. The non-transitory computer-readable storage medium of claim 14, wherein the executable instructions, when executed by the at least one processor, cause the at least one processor to decrypt the encrypted card data, based on a private key, prior to validating the encrypted card data.
